(19) United States
(12) Patent Application Publication
(10) Pub. No.: US 2020/0190261 A1
(43) Pub. Date: Jun. 18, 2020

(54) METHOD FOR PRODUCING POLYMERIC RING-OPENING PRODUCTS

(71) Applicant: COVESTRO DEUTSCHLAND AG, Leverkusen (DE)

(72) Inventors: Christoph GÜRTLER, Köln (DE); Thomas Ernst MÜLLER, Aachen (DE); Jörg HOFMANN, Krefeld (DE); Jens LANGANKE, Mechernich (DE); Matthias LEVEN, Köln (DE); Walter LEITNER, Aachen (DE)

(21) Appl. No.: 16/323,277

(22) PCT Filed: Aug. 9, 2017
(86) PCT No.: PCT/EP2017/070140

§ 371 Date: Feb. 5, 2019

(30) Foreign Application Priority Data
Aug. 12, 2016 (EP) 16184028.5
Feb. 28, 2017 (EP) 17158356.0

(51) Int. Cl. C08G 65/26; C08G 63/82; C08G 67/04; C08G 63/87

(52) U.S. Cl. CPC C08G 65/2678; C08G 65/2606; C08G 63/87; C08G 67/04; C08G 63/823

(57) ABSTRACT

The invention relates to a method for adding a compound (A) to an H-functional starting compound (BH) in the presence of a catalyst, wherein the at least one compound (A) is selected from at least one group consisting of alkylene oxide (A-1), lactone (A-2), lactide (A-3), cyclic acetal (A-4), lactam (A-5), cyclic anhydride (A-6) and oxygen-containing heterocyclic compound (A-7) different from (A-1), (A-2), (A-3), (A-4) and (A-6), wherein the catalyst comprises an organic, n-protic Brønsted acid (C), wherein n≥2 and is an element of the natural numbers and the degree of protolysis D is 0<D<n, with n as the maximum number of transferable protons and D as the calculated proton fraction of the organic, n-protic Brønsted acid (C). The invention further relates to an n-protic Brønsted acid (C) having a degree of protolysis D of 0<D<n, wherein n is the maximum number of transferable protons, with n=2, 3 or 4, and D is the calculated proton fraction of the organic, n-protic Brønsted acid (C).

The present invention relates to a process for addition of a compound (A) onto an H-functional starter compound (BH) in the presence of a catalyst, wherein the at least one compound (A) is selected from at least one group consisting of alkylene oxide (A-1), lactone (A-2), lactide (A-3), cyclic acetal (A-4), lactam (A-5), cyclic anhydride (A-6) and oxygen-containing heterocyclic compound (A-7) distinct from (A-1), (A-2), (A-3), (A-4) and (A-6), wherein the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C). The invention further relates to an n-protic Bronsted acid (C) having a degree of protolysis D of 0<D<n, wherein n is the maximum number of transferable protons where n=2, 3 or 4 and D is the calculated proton fraction of the organic, n-protic Bronsted acid (C).

The present invention further relates to polymeric ring-opening products obtainable by the process according to the invention, for example polyols and also polyurethane polymers producible therefrom.

The present invention thirdly relates to n-protic Bronsted acids (C) having a degree of protolysis D of 0<D<n, wherein n is the maximum number of transferable protons where n=2, 3 or 4 and D is the calculated proton fraction of the organic, n-protic Bronsted acid (C), wherein the degree of protolysis D for diprotic acids where n=2 is 0.2 to 1.9, for triprotic acids where n=3 is 0.3 to 2.8 and for tetraprotic acids where n=4 is 0.4 to 3.7.

At the present time, more than 11 million tonnes of polyurethane per annum are produced globally. From the aspect of a more sustainable manner of production, the use of polyols originating at least partly from renewable raw material sources is desirable as polyurethane raw materials. Suitable C₁-building blocks include in particular CO₂ and formaldehyde (J. Langanke et al., Green Chem., 2014, 16, 1865-1870 and J. Polym. Sci. A: Polym. Chem., 2015, 53, 2071-2074). These are not tied to the availability of crude oil and are also inexpensive.

Formaldehyde is polymerizable into polyoxymethylene (POM). When polymeric polyols are used as starters this affords polyoxymethylene copolymers. Sources of formaldehyde generally include gaseous formaldehyde (monomer), paraformaldehyde (polymer) and trioxane (trimer). The reaction conditions of polymerization also have a great influence on the structure of the thus obtained block copolymers: the anionic polymerization of gaseous formaldehyde in the presence of a for example difunctional starter polyol results in a triblock structure in which the starter polyol bears two POM chains which form the terminus of the block copolymer. From the aspect of chemical stability it is advantageous when the terminal OH group of a polyoxymethylene unit is derivatized in the polymer. This prevents the stepwise degradation of the POM chain.

The cationic polymerization of alkylene oxides such as for example propylene oxide, ethylene oxide onto hydroxyl groups in the presence of Lewis acids or Bronsted superacids such as for example HBH₄, HSbF₄, HPF₄, CF₃SO₃H and HClO₄ is described in “Chemistry of Polyols for Polyurethanes” by M. Ionescu in the section “Polyetherpolyols by Cationic Polymerisation Process” on page 245-246. The polymerization rate of alkylene oxides onto H-functional starter compounds and especially of propylene oxides is markedly higher than in the anionic polymerization even at low temperatures but undesired side reactions such as the formation of cyclic byproducts, such as for example dioxanes and crown ethers, result. Accordingly, acid-catalyzed cationic polymerization is unsuitable for industrial production of polyether polyols on account of the formation of the high proportion of 15-25% of cyclic oligomers.

The use of borate esters in conjunction with halides as a catalyst in the ethoxylation of base-sensitive alcohols is described in the publication by K. G. Moloy, Adv. Synth. Catal., 2010, 352, 821-826. However, only low molecular weight alcohols are ethoxylated as starter compounds and a high catalyst proportion and lengthy reaction times are necessary. In addition boric acid and esters thereof are regarded as teratogenic and mutagenic.

US 2012/0259090 A1 discloses a catalytic process for copolymerization of ethylene oxide and tetrahydrofuran, wherein a high proportion of byproducts such as oligomeric cyclic ethers are formed. The employed catalyst consists of a polymeric perfluorinated sulfonic acid produced by copolymerization of tetrafluoroethylene and CF2=CF—O—CF2CF(CF₃)—O—CF₂CF₂SO₂F and subsequent hydrolysis. Conditioning of the polymeric catalyst involves a treatment with water and ethylene oxide and subsequent drying over a period of nearly 45 hours. Moreover, only partial conversion of the ethylene oxide and tetrahydrofuran into the corresponding copolymer results despite a comparatively high catalyst loading. Byproducts are also formed.

U.S. Pat. No. 4,120,903 describes a process for acid-catalyzed polymerization of tetrahydrofuran, wherein a commercial polymer having the trade name Nafion® is employed as catalyst. The Nation® catalysts are obtained with equivalent masses of 943 to 1500 by copolymerization of tetrafluoroethylene or hexafluoropropylene with perfluorinated sulfonic acid ethers. This corresponds to calculated molar masses of the resulting copolymers of 420682 g/mol bis 2910435 g/mol. However only a partial conversion of 55.6% results despite a high catalyst loading and a long reaction time of 65 h. After removal of the unreacted tetrahydrofuran the polytetrahydrofuran is in a second reaction step stabilized by addition of 1,4-butanediol.

Furthermore, as a strongly acidic, polymeric catalyst Nafion® is known to catalyze rearrangements of alkylene oxides, wherein epoxides isomerize into the corresponding aldehydes and ketones under reaction conditions as described in Industrial & Engineering Chemistry Research, 2005, 44(23), 8468-8498.

WO2015155094 (A1) describes a process for producing polyoxymethylene block copolymers comprising the step of activating the DMC catalyst in the presence of an OH-terminated polymeric formaldehyde starter compound with a defined amount of alkylene oxide and an optional subsequent polymerization with alkylene oxides and optionally further co-comonomers. The OH-terminated polymeric formaldehyde starter compound is reacted with alkylene oxides at the mildest possible temperatures during the activation phase to avoid a depolymerization of the thermally labile/metastable H-functional starter compound. The thus obtained polyoxymethylene block copolymers are thermally and chemically stable.

WO 2004/096746 A1 and US 2006/0205915 A1 disclose the reaction of formaldehyde oligomers with alkylene oxides and/or isocyanates. In this method the described use of formaldehyde oligomers HO—(CH₂O)ₙ—H affords polyoxymethylene block copolymers having a relatively narrow molar mass distribution of n=2-19, an additional thermal removal process step being required for the provision of the formaldehyde oligomers from aqueous formalin solution. The obtained formaldehyde oligomer solutions are not storage-stable and therefore require immediate subsequent further processing.

The prior art does not describe a satisfactory method for chain extension of chemically/thermally labile H-functional starter compounds, for example polycarbonate polyols or polyacetal compounds (e.g. poly/para-formaldehyde) with alkylene oxide compounds, since known catalyst systems often catalyze the homopolymerization as a secondary reaction. Furthermore, cationically catalyzed additions of alkylene oxides onto H-functional starter compounds in the presence of Bronsted acids result in a higher proportion of undesired oligomeric byproducts.

The present application had for its object to provide improved, non-polymeric catalyst systems having sufficient reactivity which reduce the disadvantages described in the prior art in order thus to realize a more selective reaction of preferably thermally labile H-functional starter compounds with correspondingly reactive compounds, especially alkylene oxides, under the mildest possible reaction conditions to afford chain-extended addition products, especially to afford chain-extended polyols, and to reduce the proportion of undesired cyclic byproducts and degradation products and/or the formation of isomerization products such as for example of aldehydes or ketones and their possible descendent products. It is moreover desirable for the catalysts used to be free from heavy metals and for their precursors to be commercially available or for the catalysts thus to be rapidly and easily synthesized and conditioned.

The object is achieved according to the invention by a process for addition of a compound (A) onto an H-functional starter compound (BH) in the presence of a catalyst, wherein the at least one compound (A) is selected from at least one group consisting of alkylene oxide (A-1), lactone (A-2), lactide (A-3), cyclic acetal (A-4), lactam (A-5), cyclic anhydride (A-6) and oxygen-containing heterocyclic compound (A-7) distinct from (A-1), (A-2), (A-3), (A-4) and (A-6), characterized in that the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C).

In one embodiment of the process according to the invention, the addition of the compound (A) onto the H-functional starter compound (BH) in the presence of the catalyst preferably affords a ring-opening product, preferably a polymeric ring-opening product, wherein this is to be understood as meaning the optionally catalytically induced ring opening of the compound (A) in the course of the addition onto the H-functional starter compound (BH) and/or onto ring-opening products of the compound (A) that have previously undergone addition reaction.

One embodiment of the process according to the invention comprises the addition of the compound (A) onto the H-functional starter compound (BH) in the presence of a catalyst, wherein the at least one compound (A) is selected from at least one group consisting of alkylene oxide (A-1), lactone (A-2), lactide (A-3), cyclic acetal (A-4), lactam (A-5) and cyclic anhydride (A-6), wherein the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C).

A preferred embodiment of the process according to the invention comprises the addition of the compound (A) onto the H-functional starter compound (BH) in the presence of the catalyst, wherein the at least one compound (A) is selected from at least one group consisting of alkylene oxide (A-1), lactone (A-2), cyclic acetal (A-4) and cyclic anhydride (A-6), characterized in that the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C).

An alternative embodiment of the process according to the invention comprises the addition of the compound (A) onto the H-functional starter compound (BH) in the presence of a catalyst, wherein the at least one compound (A) is selected from at least one group consisting of alkylene oxide (A-1) and oxygen-containing heterocyclic compound (A-7) distinct from (A-1), (A-2), (A-3), (A-4) and (A-6), wherein the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C).

### Compound (A)

When compound (A) is an alkylene oxide (A-1) this may be for example an epoxide having 2-45 carbon atoms. In a preferred embodiment of the process the alkylene oxide (A-1) is selected from at least one compound from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, epoxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, allyl glycedyl ether, vinylcyclohexene oxide, cyclooctadiene monoepoxide, cyclododecatriene monoepoxid, butadiene monoepoxide, isoprene monoepoxide, limonene oxide, 1,4-divinylbenzene monoepoxide, 1,3-divinylbenzene monoepoxide, glycidyl acrylate and glycidylmethacrylate, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether.

In a particularly preferred embodiment of the process the alkylene oxide (A-1) is selected from at least one compound from the group consisting of ethylene oxide, propylene oxide, styrene oxide and allyl glycidyl ether are used.

In a preferred embodiment of the process the lactone (A-2) is selected from at least one compound from the group consisting of 4-membered-ring lactones such as propiolactone, β-butyrolactone, β-isovalerolactone, β-caprolactone, β-isocaprolactone, β-methyl-β-valerolactone, 5-membered-ring lactones, such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one, 6-membered-ring lactones, such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one, 7-membered-ring lactones, such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one, and lactones with higher numbers of ring members, such as (7E)-oxacycloheptadec-7-en-2-one.

In a particularly preferred embodiment of the process the lactone (A-2) is selected from at least one compound from the group consisting of ε-caprolactone, propiolactone, β-butyrolactone and γ-butyrolactone.

In a preferred embodiment of the process the lactide (A-3) is selected from at least one compound from the group consisting of glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-diones, and 3,6-di(but-3-en-1-yl)-1,4-dioxane-2,5-dione (in each case inclusive of optically active forms).

In a preferred embodiment of the process the lactide (A-3) is selected from at least one compound from the group consisting of L-lactide.

In a preferred embodiment of the process the cyclic acetal (A-4) is selected from at least one compound from the group consisting of 1,3,5-trioxane, 1,3-dioxane and 1,3-dioxolane.

In a preferred embodiment of the process the lactam (A-5) is selected from at least one compound from the group consisting of β-, γ-, δ- or ε-lactams.

When the compound (A) is a cyclic anhydride (A-6) this may contain for example 2 to 36, preferably 2 to 12, carbon atoms. In a preferred embodiment of the process the cyclic anhydride (A-6) is selected from at least one compound from the group consisting of 4-cyclohexene-1,2-dioic anhydride, 4-methyl-4-cyclohexene-1,2-dioic anhydride, 5,6-norbornene-2,3-dioic anhydride, allyl-5,6-norbornene-2,3-dioic anhydride, dodecenylsuccinic anhydride, tetradecenylsuccinic anhydride, hexadecenylsuccinic anhydride, octadecenylsuccinic anhydride, succinic anhydride, maleic anhydride, phthalic anhydride, 1,2-cyclohexanedicarboxylic anhydride, diphenic anhydride, tetrahydrophthalic anhydride, methyltetrahydrophthalic anhydride, norbornenedioic anhydride and chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3[(2E)-but-2-en-1-yl]dihydrofuran-2,5-dione.

In a particularly preferred embodiment of the process the cyclic polycarboxylic anhydride (A-6) is selected from at least one compound from the group consisting of succinic anhydride, maleic anhydride, itaconic anhydride and phthalic anhydride.

When the compound (A) is an oxygen-containing heterocyclic compound (A-7) distinct from (A-1), (A-2), (A-3), (A-4) and (A-6) this may contain for example 3 to 36, preferably 3 to 12, carbon atoms in the ring.

In a preferred embodiment of the process the oxygen-containing heterocyclic compound (A-7) distinct from (A-1), (A-2), (A-3), (A-4) and (A-6) is selected from at least one compound of the group consisting of unsubstituted or substituted oxetanes, unsubstituted or substituted oxolanes, unsubstituted or substituted oxanes and unsubstituted or substituted oxepanes.

In a particularly preferred embodiment of the process the oxygen-containing heterocyclic compound (A-7) distinct from (A-1), (A-2), (A-3), (A-4) and (A-6) is selected from at least one compound from the group consisting of trimethylene oxide, furan, tetrahydrofuran, tetrahydropyran, oxacycloheptatriene and hexamethylene oxide.

In a further preferred embodiment of the process according to the invention the at least one compound (A) is selected from the group consisting of ethylene oxide, propylene oxide, styrene oxide, allyl glycidyl ether, ε-caprolactone, propiolactone, β-butyrolactone, γ-butyrolactone, ε-caprolactam, 1,3-dioxolane, 1,4-dioxane, tetrahydrofuran and 1,3,5-trioxane. In a particularly preferred embodiment the at least one compound (A) is selected from the group consisting of ethylene oxide, propylene oxide and βbutyrolactone.

In a further preferred embodiment of the process according to the invention the at least one compound (A) is selected from the group consisting of ethylene oxide, propylene oxide, styrene oxide, allyl glycidyl ether, ε-caprolactone, propiolactone, β-butyrolactone, γ-butyrolactone, ε-caprolactam, 1,3-dioxolane and 1,3,5-trioxane. In a particularly preferred embodiment the at least one compound (A) is selected from the group consisting of ethylene oxide, propylene oxide and -butyrolactone.

In a further alternatively preferred embodiment of the process according to the invention the at least one compound (A) is selected from the group consisting of ethylene oxide, propylene oxide and tetrahydrofuran.

### Compound (BH)

Employable as suitable H-functional starter compounds (BH), also known as starters, are compounds having alkoxylation-active H atoms. Alkoxylation-active groups having active H atoms include, for example, —OH, —NH₂ (primary amines), —NH— (secondary amines), —SH, and —CO₂H, preference being given to —OH and —NH₂, particular preference being given to —OH. As H-functional starter compound one or more compounds may for example be selected from the group comprising mono- or polyvalent alcohols, polyvalent amines, polyvalent thiols, amino alcohols, thio alcohols, hydroxy esters, polyether polyols, polyester polyols, polyester ether polyols, polyether carbonate polyols, polycarbonate polyols, polycarbonates, polyacetals, polymeric formaldehyde compounds, polyethyleneimines, polyetheramines (for example the products called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (e.g. PolyTHF® from BASF, for example PolyTHF® 250, 650S, 1000, 10005, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. The C1-C23 alkyl fatty acid esters which contain on average at least 2 OH groups per molecule are, for example, commercial products such as Lupranol Balance® (BASF AG), Merginol® products (Hobum Oleochemicals GmbH), Sovermol® products (Cognis Deutschland GmbH & Co. KG), and Soyol®™ products (USSC Co.).

In a preferred embodiment of the process according to the invention the compound (BH) is selected from the group consisting of polyether polyol, polyether carbonate polyol and polycarbonate polyol. Production of the polyether carbonate polyol and of the polycarbonate polyol is carried out by catalytic addition of carbon dioxide and alkylene oxides onto a further H-functional starter compound. Production of the polyether carbonate polyol and of the polycarbonate polyol is preferably carried out by catalytic addition of carbon dioxide and ethylene oxide and/or propylene oxide onto a further H-functional starter compound. Employable monofunctional starter compounds include alcohols, amines, thiols and carboxylic acids. Employable monofunctional alcohols include: methanol, ethanol, 1-propanol, 2-propanol, 1-butanol, 2-butanol, tert-butanol, 3-buten-1-ol, 3-Butyn-1-ol, 2-methyl-3-buten-2-ol, 2 methyl-3-Butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Employable monofunctional thiols include: ethanethiol, 1-propanethiol, 2-propanethiol, 1-butanethiol, 3-methyl-1-butanethiol, 2-butene-1-thiol, thiophenol. Examples of monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyvalent alcohols suitable as H-functional starter compounds include for example divalent alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantanediol, methylpentanediols (such as, for example, 3-methyl-1,5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trivalent alcohols (such as, for example, trimethylolpropane, glycerol, trishydroxyethyl isocyanurate, castor oil); tetravalent alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all products of modification of these aforementioned alcohols with different amounts of ε-caprolactone.

The H-functional starter compounds may also be selected from the substance class of the polyether polyols, in particular those having a molecular weight Mₙ in the range from 100 to 4000 g/mol. Preference is given to polyether polyols made up of repeating ethylene oxide and propylene oxide units, preferably having a proportion of 35% to 100% of propylene oxide units, particularly preferably having a proportion of 50% to 100% of propylene oxide units. These may be random copolymers, gradient copolymers, alternating copolymers or block copolymers of ethylene oxide and propylene oxide. Suitable polyether polyols constructed from repeating propylene oxide and/or ethylene oxide units are, for example, the Desmophen®, Acclaim®, Arcol®, Baycoll®, Bayfill®, Bayflex®, Baygal®, PET® and polyether polyols from Covestro AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE, and suitable mixed copolymers of ethylene oxide and propylene oxide are, for example, the Pluronic® PE or Pluriol® RPE products from BASF SE.

The H-functional starter compounds may also be selected from the substance class of the polyester polyols, in particular those having a molecular weight Mₙ in the range from 200 to 4500 g/mol. Polyesters having a functionality of at least two may be used as the polyester polyols. It is preferable when polyester polyols consist of alternating acid and alcohol units. Employable acid components include for example succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the recited acids and/or anhydrides. Alcohol components employed include for example ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the stated alcohols. Employing divalent or polyvalent polyether polyols as the alcohol component affords polyester ether polyols which can likewise serve as starter compounds for producing the polyether carbonate polyols. It is preferable to use polyether polyols where Mₙ=150 to 2000 g/mol for producing the polyester ether polyols. H-functional starter compounds that may be employed further include polycarbonate diols, in particular those having a molecular weight Mₙ in the range from 150 to 4500 g/mol, preferably 500 to 2500 g/mol, prepared, for example, by reaction of phosgene, dimethyl carbonate, diethyl carbonate or diphenyl carbonate with difunctional alcohols or polyester polyols or polyether polyols. Examples relating to polycarbonates may be found for example in EP-A 1359177. Employable polycarbonate diols include for example the Desmophen® C-products from CovestroAG, for example Desmophen® C 1100 or Desmophen® C 2200.

A further embodiment of the invention may employ polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols as H-functional starter compounds. Polyether carbonate polyols, polycarbonate polyols and/or polyether ester carbonate polyols may in particular be obtained by reaction of alkylene oxides, preferably ethylene oxide, propylene oxide or mixtures thereof, optionally further comonomers, with CO₂ in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO₂ is provided for example in Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter compounds may be produced beforehand in a separate reaction step.

The H-functional starter compounds generally have an OH functionality (i.e., number of polymerization-active H atoms per molecule) of 1 to 8, preferably of 2 to 6 and particularly preferably of 2 to 4. The H-functional starter compounds are used either individually or as a mixture of at least two H-functional starter compounds.

Preferred H-functional starter compounds are alcohols having a composition according to general formula (I),

HO—(CH₂)ₓ—OH

wherein x is from 1 to 20, preferably an even number from 2 to 20. Examples of alcohols according to formula (I) are ethylene glycol, 1,4-butanediol, 1,6-hexanediol, 1,8-octanediol, 1,10-decanediol and 1,12-dodecanediol. Further preferred H-functional starter compounds are neopentyl glycol, trimethylolpropane, glycerol, pentaerythritol, reaction products of the alcohols of formula (VII) with ε-caprolactone, for example reaction products of trimethylolpropane with ε-caprolactone, reaction products of glycerol with ε-caprolactone and reaction products of pentaerythritol with ε-caprolactone. Preferably employed H-functional starter compounds further include water, diethylene glycol, dipropylene glycol, castor oil, sorbitol and polyether polyols constructed from repeating polyalkylene oxide units.

It is particularly preferable when the H-functional starter compounds are one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane, di- and trifunctional polyether polyols, wherein the polyether polyol is constructed from a di- or tri-H-functional starter compound and propylene oxide or a di- or tri-H-functional starter compound, propylene oxide and ethylene oxide. The polyether polyols preferably have an OH functionality of 2 to 4 and a molecular weight Mₙ in the range from 62 to 8000 g/mol, preferably a molecular weight and more preferably of ≥92 to ≤2000 g/mol.

A further embodiment of the invention may employ polyacetals, preferably polymeric formaldehyde compounds, as H-functional starter compounds for the process according to the invention, oligomeric and polymeric forms of formaldehyde having at least one terminal hydroxyl group for reaction with the compound (A) being suitable in principle. According to the invention, the term “terminal hydroxyl group” is to be understood as meaning in particular a terminal hemiacetal functionality which is formed as a structural feature by the polymerization of formaldehyde. For example the starter compounds may be oligomers and polymers of formaldehyde of general formula (I), wherein n is an integer ≥2 and wherein polymeric formaldehyde typically has n>8 repeating units.

Polymeric formaldehyde starter compounds suitable for the process of the invention generally have molar masses of 62 to 30 000 g/mol, preferably of 62 to 12 000 g/mol, particularly preferably of 242 to 6000 g/mol and very particularly preferably of 242 to 3000 g/mol, and comprise from 2 to 1000, preferably from 2 to 400, particularly preferably from 8 to 200 and very particularly preferably from 8 to 100 oxymethylene repeating units. The starter compounds employed in the process according to the invention typically have a functionality (F) of 1 to 3, but in certain cases may also have higher functionality, i.e. have a functionality of >3. It is preferable to employ in the process according to the invention open-chain polymeric formaldehyde starter compounds having terminal hydroxyl groups and having a functionality of 1 to 10, preferably of 1 to 5, particularly preferably of 2 to 3.

Employed with very particular preference in the process according to the invention are linear polymeric formaldehyde starter compounds having a functionality of 2 (e.g. GRANUFORM® from Ineos). The functionality F corresponds to the number of OH end groups per molecule.

Production of the polymeric formaldehyde starter compounds used for the process according to the invention may be carried out by known processes (cf., for example, M. Haubs et al., 2012, Polyoxymethylenes, Ullmann's Encyclopedia of Industrial Chemistry; G. Reus et al., 2012, Formaldehyde, ibid.). The formaldehyde starter compounds may in principle also be employed in the process according to the invention in the form of a copolymer, wherein comonomers included in the polymer in addition to formaldehyde are, for example, 1,4-dioxane or 1,3-dioxolane. Further suitable formaldehyde copolymers for the process according to the invention are copolymers of formaldehyde and of trioxane with cyclic and/or linear formals, for example butanediol formal, or epoxides. It is likewise conceivable for higher homologous aldehydes, for example acetaldehyde, propionaldehyde, etc, to be incorporated into the formaldehyde polymer as comonomers. It is likewise conceivable for formaldehyde starter compounds according to the invention to in turn be prepared from H-functional starter compounds; obtainable here in particular through the use of polyfunctional starter compounds are polymeric formaldehyde starter compounds having a hydroxyl end group functionality F>2 (cf., for example, WO 1981001712 A1, Bull. Chem. Soc. J., 1994, 67, 2560-2566, U.S. Pat. No. 3,436,375, JP 03263454, JP 2928823).

Also employable for the process according to the invention are mixtures of different polymeric formaldehyde starter compounds or mixtures with other H-functional starter compounds. Employable as a suitable H-functional starter compound (starters) are compounds having alkoxylation-active H atoms which have a molar mass of 18 to 4500 g/mol, preferably of 62 to 2500 g/mol and particularly preferably of 62 to 1000 g/mol. Alkoxylation-active groups having active H atoms include, for example, —OH, —NH₂ (primary amines), —NH— (secondary amines), —SH, and —CO₂H, preference being given to —OH and —NH₂, particular preference being given to —OH. Employed as the H-functional starter compound are for example one or more compounds selected from the group consisting of mono- and polyvalent alcohols, polyvalent amines, polyvalent thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule.

As is well known, polymerization of formaldehyde already proceeds due to the presence of small traces of water. In aqueous solution a mixture of oligomers and polymers of different chain lengths which are in equilibrium with molecular formaldehyde and formaldehyde hydrate is thus formed according to the concentration and the temperature of the solution. So-called paraformaldehyde here precipitates out of the solution as a white, poorly soluble solid and is generally a mixture of linear formaldehyde polymers where n=8 to 100 oxymethylene repeating units.

One advantage of the process according to the invention is in particular that polymeric formaldehyde/so-called paraformaldehyde, which is an inexpensive and commercially available product and moreover has a low carbon footprint, may be used directly as a starter compound without any need for additional preparatory steps here. An advantageous embodiment of the invention thus employs paraformaldehyde as the starter compound. In particular the molecular weight and the end group functionality of the polymeric formaldehyde starter compound make it possible to introduce polyoxymethylene blocks of defined molar weight and functionality into the product.

The length of the polyoxymethylene block may here advantageously be controlled in simple fashion in the process according to the invention via the molecular weight of the employed formaldehyde starter compound. Preferably employed here are linear formaldehyde starter compounds of general formula (I), wherein n is an integer≥2, preferably where n=2 to 1000, particularly preferably where n=2 to 400 and very particularly preferably where n=8 to 100, having two terminal hydroxyl groups. Also employable as starter compounds are in particular mixtures of polymeric formaldehyde compounds of formula (I) each having different values of n. In an advantageous embodiment the employed mixtures of polymeric formaldehyde starter compounds of formula (I) contain at least 1% by weight, preferably at least 5% by weight and particularly preferably at least 10% by weight of polymeric formaldehyde compounds where n≥20.

In one embodiment of the process according to the invention the molar ratio of the compound (A) to the H-functional starter compound (BH) in the resulting addition product is ≥1, preferably 1 to 200, particularly preferably 1-150.

n-protic Bronsted Acid (C)

In the context of the present invention the term “organic, n-protic Bronsted acid (C)” is to be understood as meaning an organic, non-polymeric compound constructed from carbon, hydrogen and oxygen and optionally a further heteroatom distinct from the abovementioned atoms, preferably containing a further heteroatom. In line with the customary definition in the art Bronsted acids are to be understood as meaning substances which may transfer protons to a second reaction partner, the so-called Bronsted base, typically in an aqueous medium at 25° C. In the process according to the invention the maximum number of transferable protons n is n≥2, preferably n=2, 3 or 4, particularly preferably n=2 or 3, very particularly preferably n=2, wherein n is an element of the natural numbers. The calculated proton fraction of the organic, n-protic Bronsted acid (C) corresponds to the degree of protolysis D and in the process according to the invention is 0<D<n. For diprotic acids where n=2 the degree of protolysis D is preferably 0.2 to 1.9, particularly preferably 0.5 to 1.8 and very particularly preferably 0.8 to 1.8. For triprotic acids where n=3 the degree of protolysis D is preferably 0.3 to 2.8, particularly preferably 0.7 to 2.5 and very particularly preferably 1.1 to 2.1. For tetraprotic acids where n=4 the degree of protolysis D is preferably 0.4 to 3.7, particularly preferably 0.8 to 3.5 and very particularly preferably 1.1 to 3.1.

In embodiment the invention relates to a process wherein the compound (C) is a non-polymeric compound.

In embodiment the invention relates to a process, wherein the organic, n-protic Bronsted acid (C) has a calculated molar mass of ≤1200 g/mol, preferably of ≤1000 g/mol and particularly preferably of ≤850 g/mol.

In embodiment the invention relates to a process, wherein the organic, n-protic Bronsted acid (C) has a calculated molar mass of ≥90 g/mol, preferably of ≥100 g/mol and particularly preferably of ≥110 g/mol.

In embodiment the invention relates to a process, wherein the organic, n-protic Bronsted acid (C) has a calculated molar mass of ≥90 g/mol to ≤1200 g/mol, preferably of ≥90 g/mol to ≤1000 g/mol and particularly preferably of ≥100 g/mol to ≤850 g/mol.

In one embodiment of the process according to the invention the organic, n-protic Bronsted acid (C) is a sulfonic acid, wherein in line with the customary definition in the art a sulfonic acid is to be understood as meaning an organic sulfur compounds having the general structure R—SO₂—OH, wherein R is an organic radical. Here R—SO₂—OH or, for short, R—SO₃H represents the sulfonic acid and R—SO₃° represents the deprotonated sulfonate group formed by proton donation to a second reaction partner, the so-called Bronsted base. The organic radical R corresponds to linear cyclic or linear branched alkylene group having 1 to 22 carbon atoms optionally containing further heteroatoms and/or aryl groups having 5 to 18 carbon atoms optionally containing further heteroatoms.

In a preferred embodiment substituted or unsubstituted aromatic non-polymeric polysulfonic acids having a maximum number of transferable protons n of n=2, 3 oder 4 are employed. In a particularly preferred embodiment substituted or unsubstituted naphthalenepolysulfonic acids where n=2 or 3 and/or substituted or unsubstituted benzenepolysulfonic acids where n=2 or 3 are employed. It is very particularly preferable when 1,5-naphthalenedisulfonic acids, 2,6-naphthalenedisulfonic acids and/or 1,3-benzenedisulfonic acids where n=2 are. For diprotic sulfonic acids where n=2 the degree of protolysis D is preferably 0.2 to 1.9, particularly preferably 0.5 to 1.8 and very particularly preferably 0.8 to 1.8. For triprotic sulfonic acids where n=3 the degree of protolysis D is preferably 0.3 to 2.8, particularly preferably 0.7 to 2.5 and very particularly preferably 1.1 to 2.1. For tetraprotic sulfonic acids where n=4 the degree of protolysis D is preferably 0.4 to 3.7, particularly preferably 0.8 to 3.5 and very particularly preferably 1.1 to 3.1.

In embodiment the invention relates to a process, wherein the sulfonic acid has a calculated molar mass of ≥160 g/mol to ≤1200 g/mol, preferably of ≥200 g/mol to ≤1000 g/mol and particularly preferably of ≥230 g/mol to ≤850 g/mol.

In one embodiment of the process according to the invention the organic, n-protic Bronsted acid (C) having the degree of protolysis 0<D<n is obtained by acid-base reactions with proton transfer by
(α) addition of suitable amounts of suitable Bronsted bases (E) to the organic, n-protic Bronsted acids or
(β) addition of suitable amounts of suitable Bronsted acids (E′H) to the salts of the organic, n-protic Bronsted acids.

### Step α

In a preferred embodiment of step (α) the organic, n-protic Bronsted acid (C) having the degree of protolysis 0<D<n is obtained by acid-base reactions with proton transfer by addition of suitable amounts of a suitable Bronsted base (E) to the completely or partially protonated organic, n-protic Bronsted acid, wherein a suitable Bronsted base (E) has a greater base strength K_{b}(E) and thus a smaller pK_{b}(E) than the completely or partially protonated organic, n-protic Bronsted acid. The suitable amount of the Bronsted base (E) is derived for example from the desired degree of protolysis (D) of the organic, n-protic Bronsted acid (C) and/or the base strength K_{b}(E) of the employed Bronsted base (E).

Such an organic, n-protic Bronsted acid (C) having a degree of protolysis (D) in the range 0<D<n is obtainable for example by reaction of completely or partially protonated organic, n-protic Bronsted acids, preferably completely protonated sulfonic acids, by addition of Bronsted bases (E) having a pK_{b}(E) of ≤10, preferably having a pK_{b}(E) of ≤8 and very particularly preferably having a pK_{b}(E) of ≤5. It is particularly preferable when disulfonic acids are reacted with metal orthovanadates, metal tungstates, metal hydrogentriphosphates, metal hydrogenphospates, metal sulfites, metal trithiocarbonates, metal carbonates, metal hydrogencarbonates, alkali metal hydroxides, alkaline earth metal hydroxides, titanium hydroxide, zinc hydroxide, aluminum hydroxide, vanadium and vanadyl hydroxides, iron(II) and iron(III) hydroxides, bismuth(III) hydroxide, gallium(III) hydroxide, copper(II) hydroxide, manganese(II) hydroxide, silver hydroxide, ammonium hydroxides, phosphonium hydroxides, sulfonium hydroxides, sulfoxonium hydroxides, alkali metal alkoxides, alkaline earth metal alkoxides, titanium alkoxides, zinc alkoxides, aluminum alkoxide, ammonium alkoxides, phosphonium alkoxides, sulfoniumalkoxides, sulfoxonium alkoxides, alkali metal alkoxylates, alkaline earth metal alkoxylates, titanium alkoxylates, zinc alkoxylates, aluminum alkoxylate, ammonium alkoxylates, phosphonium alkoxylates, sulfonium alkoxylates, sulfoxonium alkoxylates, metal benzoates, metal acetates, metal phenyolates, hydrazine, methyl- and ethylhydrazine, metal azides, hydroxylamine, ammonia, substituted aliphatic and cycloaliphatic mono-/di-/triamines with primary, secondary or tertiary amine functions, lithium diisopropylamide, lithium organyls, amidine bases, amides, alkali metal hydrides, alkaline earth metal hydrides, titanium hydrides, zinc hydrides, aluminum hydride, ammonium hydrides, phosphonium hydrides, sulfoniumhydrides and/or sulfoxonium hydrides as Bronsted bases (E) to afford the organic, n-protic Bronsted acid (C) having a degree of protolysis (D) in the range 0<D<n. It is very particularly preferable when benzene-1,3-disulfonic acid, naphthalene-1,5-disulfonic acid and/or naphthalene-2,6-disulfonic acid are reacted with lithium hydroxides, sodium hydroxides, potassium hydroxides, rubidium hydroxides, cesium hydroxides, magnesium hydroxides, calcium hydroxides, strontium hydroxides, barium hydroxides, scandium hydroxides, titanium hydroxides, zinc hydroxides, aluminum hydroxides, aliphatic primary ammonium hydroxides, aliphatic secondary ammonium hydroxides, aliphatic tertiary ammonium hydroxides, aliphatic quaternary ammonium hydroxides, phosphonium hydroxides, aliphatic primary ammonium alkoxides, aliphatic secondary ammonium alkoxides, aliphatic tertiary ammonium alkoxides, aliphatic quaternary ammonium alkoxides, phosphonium alkoxides, butylithium, potassium tert-butoxide, 1,8-diazabicyclo[5.4.0]undec-7-ene (DBU), 1,5-diazabicyclo(4.3.0)non-5-ene (DBN) and/or primary, secondary and tertiary aliphatic and cycloaliphatic mono- and diamines, preferably with sodium hydroxide, potassium hydroxide, lithium hydroxide, magnesium hydroxide, calcium hydroxide, aliphatic quaternary ammonium alkoxides, phosphonium alkoxides, ammonia, triethylamine, trimethylamine, diethylamine, propylamine, methylamine, dimethylamine, ethylamine, ethylenediamine, 1,3-diaminopropanes, putrescine, 1,5-diaminopentane, hexamethylenediamine, 1,2-diaminopropanes, diaminocyclohexane, n-propylamine, di-n-propylamine, tri-n-propylamin, isopropylamine, diisopropylamine, n-butylamine, di-n-butylamine, tri-n-butylamine, diisobutylamine, 2-aminobutane, 2-ethylhexylamine, di-2-ethylhexylamine, cyclohexylamine, dicyclohexylamine, dimethylaminopropylamine, triethylenediamine, 1,8-diazabicyclo[5.4.0]undec-7-ene (DBU), 1,5-diazabicyclo(4.3.0)non-5-ene (DBN), particularly preferably with sodium hydroxide, potassium hydroxide, lithium hydroxide, magnesium hydroxide, tetra(n-butyl)ammonium methoxide, tetra(n-butyl)ammonium ethoxide and/or tetra(n-butyl)ammonium isopropoxide, as Bronsted bases (E) to afford the organic, n-protic Bronsted acid (C) having a degree of protolysis (D) in the range 0<D<n.

The acid-base reactions due to the addition of the Bronsted base (E) to the completely or partially protonated organic, n-protic Bronsted acid result not only in the formation of the organic, n-protic Bronsted acid (C) where 0<D<n but also in the formation of the corresponding Bronsted acid (EH) by proton acceptance, wherein the corresponding Bronsted acids (EH) formed are preferably alcohols or water and very preferably water, methanol, isopropanol or ethanol.

In a particularly preferred embodiment of (α) the formation of the organic, n-protic Bronsted acid (C) in step (α) is or is not followed by a separation of the corresponding Bronsted acid (EH) which is formed from the Bronsted base (E) by proton acceptance. It is preferable when the corresponding Bronsted acid (EH) is separated by distillation.

### Step β

In a preferred embodiment of step (β) the organic, n-protic Bronsted acid (C) having the degree of protolysis 0<D<n is obtained by acid-base reactions with proton transfer by a suitable Bronsted acid (E′H) to the salts of the partially or completely deprotonated organic, n-protic Bronsted acid, wherein a suitable Bronsted acid (E′H) has a greater acid strength Kₐ(E′H) and thus a smaller pKₐ(E′H) than the completely or partially deprotonated organic, n-protic Bronsted acid. The suitable amount of the Bronsted acid (E′H) is derived for example from the desired degree of protolysis (D) of the organic, n-protic Bronsted acid (C) and/or the acid strength Kₐ(E′H) of the employed Bronsted acid (E′H).

For example such an organic, n-protic Bronsted acid (C) having a degree of protolysis (D) in the range 0<D<n may be obtained by reaction of a completely or partially deprotonated metal salt of an organic, n-protic Bronsted acid, preferably a metal salt of a sulfonic acid, by addition of strong Bronsted acid (E′H) having a pKₐ(E′H) of ≤1. It is particularly preferable when dialkali metal salts and/or diammonium salts of a disulfonic acid are reacted with strong organic and/or inorganic Bronsted acids (E′H) having a pKₐ(E′H) of ≤1 to afford the organic, n-protic Bronsted acid (C) having a degree of protolysis (D) in the range 0<D<n. It is very particularly preferable when the disodium and/or the dipotassium salts of benzene-1,3-disulfonic acid, naphthalene-1,5-disulfonic acid and/or naphthalene-2,6-disulfic acid are reacted with aliphatic and aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, aromatic sulfonic acids, aliphatic sulfonic acids, preferably with trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, methanesulfonic acid, paratoluenesulfonic acid and particularly preferably with trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid, trifluoroacetic acid, to afford the organic, n-protic Bronsted acid (C) having a degree of protolysis (D) in the range 0<D<n.

The acid-base reactions due to the addition of the Bronsted acid (E′H) to the completely or partially deprotonated organic, n-protic Bronsted acid result not only in the formation of the organic, n-protic Bronsted acid (C) where 0<D<n but also in the formation of the corresponding Bronsted base (E′) by proton donation, wherein the corresponding Bronsted acids (EH) formed are preferably metal salts, phosphonium salts or ammonium salts and particularly preferably alkali metal salts or ammonium salts and very preferably sodium hydrogensulfate, potassium hydrogensulfate, lithium hydrogensulfate, sodium triflate, potassium triflate, lithium triflate and/or ammonium triflate.

In a particularly preferred embodiment the formation of the organic, n-protic Bronsted acid (C) in step (β) is or is not followed by a separation of the corresponding Bronsted base (E′) which is formed from the Bronsted base (E′) by proton donation. It is preferable when the corresponding Bronsted acid (E′) is not separated.

In a further embodiment of the process the organic, n-protic Bronsted acid (C) is employed in an amount of 0.0001 mol % to 10 mol % based on the amount of substance of the compound (BH).

In a further embodiment of the process according to the invention the addition of the compound (A) onto the H-functional starter compound (BH) in the presence of the organic, n-protic Bronsted acid (C) is performed under the mildest possible reaction temperatures of 20° C. to 180° C. in order to reduce for example decomposition reactions or undesired side reactions of chemically/thermally labile H-functional starter compounds (BH) such as for example polycarbonate polyols or polyacetal compounds. The reaction of the compound (BH) with (A) in the presence of the organic, n-protic Bronsted acid (C) may be carried out under isothermal or adiabatic conditions optionally with a defined temperature profile.

In a further embodiment of the process according to the invention the addition of the compound (A) onto the H-functional starter compound (BH) in the presence of the organic, n-protic Bronsted acid (C) is performed in reaction times of up to 24 h, preferably up to 20 h, particularly preferably up to 12 h.

In a further embodiment the process may be performed in a batch mode, semi-batch mode or continuous mode.

In a further embodiment of the process according to the invention the addition of the compound (A) onto the H-functional starter compound (BH) in the presence of the organic, n-protic Bronsted acid (C) is performed solventlessly or in a solvent. Preferred solvents are polar or nonpolar aprotic solvents. Particular preference is given to solvents selected from the group consisting of cyclic propylene carbonate, ethyl acetate, iso-propyl acetate, n-butyl acetate, tetrahydrofuran, 1,3-dioxolane, 1,3,5-trioxepane, 1,4-dioxane, dimethyldioxane, methyl phenyl ether and toluene.

In a further embodiment of the process according to the invention the organic, n-protic Bronsted acid (C) may also be produced directly in the presence of the starter (BH) in the presence or absence of a further solvent. Preferably employed here are chlorinated solvents and particularly preferably dichloromethane and/or chloroform.

In embodiment the invention relates to an n-protic Bronsted acid (C), wherein the n-protic Bronsted acid (C) has a calculated molar mass of ≥90 g/mol to ≤1200 g/mol, preferably of ≥100 g/mol to ≤1000 g/mol and particularly preferably of ≥110 g/mol to ≤850 g/mol.

The invention also provides a ring-opening product, preferably of a polyvalent alcohol, polyvalent amine, polyvalent thiol, amino alcohol, thioalcohol, hydroxyester, polyether polyol, polyester polyol, polyester ether polyol, polyether carbonate polyol, polycarbonate polyol, polycarbonate, polymeric formaldehyde compound, polyamide, obtainable by a process as described in the preceding pages.

A further aspect of the invention is a polyurethane polymer obtainable by reaction comprising the ring-opening product according to the invention, preferably a polyvalent alcohol, polyvalent amine, polyvalent thiol, amino alcohol, thioalcohol, hydroxyester, polyether polyol, polyester polyol, polyester ether polyol, polyether carbonate polyol, polycarbonate polyol, polycarbonate, polymeric formaldehyde compound, polyamide, with an isocyanate component comprising a polyisocyanate.

The isocyanate may be an aliphatic or aromatic di- or polyisocyanate. Examples include 1,4-butylene diisocyanate, 1,5-pentane diisocyanate, 1,6-hexamethylene diisocyanate (HDI) and dimers, trimers, pentamers, heptamers or nonamers or mixtures thereof, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C1 to C6-alkyl groups. Preference is given here to an isocyanate from the diphenylmethane diisocyanate series.

In addition to the abovementioned polyisocyanates, it is also possible to use proportions of modified diisocyanates of uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

It is possible for the isocyanate to be a prepolymer obtainable by reaction of an isocyanate having an NCO functionality of ≥2 and ring-opening products, preferably of a polyvalent alcohol, polyvalent amine, polyvalent thiol, amino alcohol, thioalcohol, hydroxyester, polyether polyol, polyester polyol, polyester ether polyol, polyether carbonate polyol, polycarbonate polyol, polycarbonate, polymeric formaldehyde compound, polyamide, and having a molecular weight of ≥62 g/mol to ≤8000 g/mol and OH functionalities of ≥1.5 to ≤6.

The invention further provides an n-protic Bronsted acid (C) having a degree of protolysis D 0<D<n, wherein n is the maximum number of transferable protons where n=2, 3 or 4 and D is the calculated proton fraction of the organic, n-protic Bronsted acid (C),

characterized in that acids where n=2 is 0.2 to 1.9, for triprotic acid where n=3 is 0.3 to 2.8, for tetraprotic acids where n=4 is 0.4 to 3.7, wherein the organic, n-protic Bronsted acid (C) having the degree of protolysis 0<D<n is obtained by acid-base reactions with proton transfer by
(α) addition of suitable amounts of at least one suitable Bronsted base (E) to the at least one organic, n-protic Bronsted acid, wherein the Bronsted base (E) contains at least one cation (F) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations
   or
(β) addition of suitable amounts of at least one suitable Bronsted acid (E′H) to the salt of the at least one organic, n-protic Bronsted acid, wherein the salts of the organic, n-protic Bronsted acid contain at least one cation (F′) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations.

In one embodiment of the n-protic Bronsted acid (C) according to the invention the cation (F) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

In one embodiment of the n-protic Bronsted acid (C) according to the invention the cation (F′) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

In one embodiment of the n-protic Bronsted acid (C) according to the invention the at least one Bronsted base (E) is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, scandium hydroxide, titanium hydroxide, zinc hydroxide, aluminum hydroxide, aliphatic primary ammonium hydroxides, aliphatic secondary ammonium hydroxides, aliphatic tertiary ammonium hydroxides, aliphatic quaternary ammonium hydroxides, phosphonium hydroxides, aliphatic primary ammonium alkoxides, aliphatic secondary ammonium alkoxides, aliphatic tertiary ammonium alkoxides, aliphatic quaternary ammonium alkoxides, phosphonium alkoxides, butylithium, potassium tert-butoxide, 1,8-diazabicyclo[5.4.0]undec-7-ene (DBU), 1,5-diazabicyclo(4.3.0)non-5-ene (DBN), primary aliphatic amines, secondary aliphatic amines, tertiary aliphatic amines, primary cycloaliphatic amines, secondary cycloaliphatic amines, tertiary cycloaliphatic amines and phosphonium alkoxides, preferably from sodium hydroxide, potassium hydroxide, lithium hydroxide, magnesium hydroxide, calcium hydroxide, aliphatic quaternary ammonium alkoxides, phosphonium alkoxides, ammonia, triethylamine, trimethylamine, diethylamine, propylamine, methylamine, dimethylamine, ethylamine, ethylenediamine, 1,3-diaminopropanes, putrescine, 1,5-diaminopentane, hexamethylenediamine, 1,2-diaminopropanes, diaminocyclohexane, n-propylamine, di-n-propylamine, tri-n-propylamine, isopropylamine, diisopropylamine, n-butylamine, di-n-butylamine, tri-n-butylamine, diisobutylamine, 2-aminobutane, 2-ethylhexylamine, di-2-ethylhexylamine, cyclohexylamine, dicyclohexylamine, dimethylaminopropylamine, triethylenediamine, 1,8-diazabicyclo[5.4.0]undec-7-ene (DBU) and 1,5-diazabicyclo(4.3.0)non-5-ene (DBN), particularly preferably from sodium hydroxide, potassium hydroxide, lithium hydroxide, magnesium hydroxide, tetra(n-butyl)ammonium methoxide, tetra(n-butyl)ammonium ethoxide and tetra(n-butyl)ammonium isopropoxide.

In one embodiment of the n-protic Bronsted acid (C) according to the invention the at least one Bronsted acid (E′H) is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

In one embodiment of the n-protic Bronsted acid (C) according to the invention a diprotic acid where n=2 having a degree of protolysis D of 0.8 to 1.8, preferably 1.1 to 1.7, is used.

In one embodiment the n-protic Bronsted acid (C) is at least one sulfonic acid.

In one embodiment of the n-protic Bronsted acid (C) according to the invention the sulfonic acid is selected from the group consisting of at least one substituted or unsubstituted naphthalenepolysulfonic acid where n=2 or 3 and/or at least one substituted or unsubstituted benzenepolysulfonic acid where n=2 or 3.

In one embodiment of the n-protic Bronsted acid (C) according to the invention the degree of protolysis D of the sulfonic acid for diprotic acids where n=2 is 0.8 to 1.8 and for triprotic acids where n=3 is 1.1 to 2.1.

In one embodiment of the n-protic Bronsted acid (C) according to the invention the sulfonic acid is selected from the group consisting of 1,5-naphthalenedisulfonic acid, 2,6-naphthalenedisulfonic acid and 1,3-benzenedisulfonic acid, preferably 1,5-naphthalenedisulfonic acid, 2,6-naphthalenedisulfonic acid and very particularly preferably 2,6-naphthalenedisulfonic acid, wherein in a preferred embodiment the degree of protolysis D is 0.8 to 1.8, preferably 1.1 to 1.7.

In a further embodiment the n-protic Bronsted acid (C) is used as a catalyst, additive, for example as a foaming agent/stabilizer or starter, preferably as a catalyst.

In a first embodiment the invention relates to a process for addition of a compound (A) onto an H-functional starter compound (BH) in the presence of a catalyst, wherein the at least one compound (A) is selected from at least one group consisting of alkylene oxide (A-1), lactone (A-2), lactide (A-3), cyclic acetal (A-4), lactam (A-5), cyclic anhydrides (A-6) and oxygen-containing heterocyclic compound (A-7) distinct from (A-1), (A-2), (A-3), (A-4) and (A-6), wherein the catalyst comprises an organic, n-protic Bronsted acid (C), wherein n≥2 and is an element of the natural numbers and the degree of protolysis D is 0<D<n where n is the maximum number of transferable protons and D is the calculated proton fraction of the organic, n-protic Bronsted acid (C).

In a second embodiment the invention relates to a process according to the first embodiment, wherein the compound (A) is selected from at least one group consisting of alkylene oxide (A-1), lactone (A-2), cyclic acetal (A-4) and cyclic anhydride (A-6).

In a third embodiment, the invention relates to a process according to the first or second embodiment, wherein the organic, n-protic Bronsted acid (C) is a sulfonic acid.

In a fourth embodiment the invention relates to a process according to any of the first to third embodiments, wherein the maximum number of transferable protons n is n=2, 3 or 4.

In a fifth embodiment the invention relates to a process according to the fourth embodiment, wherein the degree of protolysis D for diprotic acids where n=2 is 0.2 to 1.9, for triprotic acids where n=3 is 0.3 to 2.8 and for tetraprotic acids where n=4 is 0.4 to 3.7.

In a sixth embodiment the invention relates to a process according to any of the first to fifth embodiments, wherein the organic, n-protic Bronsted acid (C) having the degree of protolysis 0<D<n is obtained by acid-base reactions with proton transfer by
(α) addition of suitable amounts of suitable Bronsted bases (E) to the organic, n-protic Bronsted acids or
   addition of suitable amounts of suitable Bronsted acids (E′H) to the salts of the organic, n-protic Bronsted acids.

In a seventh embodiment the invention relates to a process according to the sixth embodiment, wherein the organic, n-protic Bronsted acid (C) having the degree of protolysis 0<D<n is obtained by acid-base reactions with proton transfer in step
(α) by addition of Bronsted bases (E) having a pK_{b}(E) of ≤10, preferably having a pK_{b}(E) of ≤8 and very particularly preferably having a pK_{b}(E) of ≤5 to the completely protonated sulfonic acids or
   by addition of strong Bronsted acids (E′H) having a pKₐ(E′H) of ≤1 to the metal salt of a sulfonic acid.

In an eighth embodiment the invention relates to a process according to any of the first to seventh embodiments, wherein the at least one compound (A) is selected from the group consisting of ethylene oxide, propylene oxide, styrene oxide, allyl glycidyl ether, ε-caprolactone, propiolactone, β-butyrolactone, γ-butyrolactone, ε-caprolactam, 1,3-dioxolane, 1,4-dioxane, tetrahydrofuran and 1,3,5-trioxane.

In a ninth embodiment the invention relates to a process according to any of the first to eighth embodiments, wherein the compound (BH) is selected from one or more compounds selected from the group consisting of mono- or polyvalent alcohols, polyvalent amines, polyvalent thiols, amino alcohols, thio alcohols, hydroxy esters, polyether polyols, polyester polyols, polyester ether polyols, polyether carbonate polyols, polycarbonate polyols, polycarbonates, polyacetals, polymeric formaldehyde compounds, polyethyleneimines, polyetheramines, polytetrahydrofurans, polytetrahydrofuranamines, polyether thiols, polyacrylate polyols, castor oil, the mono- or diglyceride of ricinoleic acid, monoglycerides of fatty acids, chemically modified mono-, di- and/or triglycerides of fatty acids and C1-C24 alkyl fatty acid esters containing on average at least 2 OH groups per molecule.

In a tenth embodiment the invention relates to an n-protic Bronsted acid (C) having a degree of protolysis D 0<D<n, wherein n is the maximum number of transferable protons where n=2, 3 or 4 and D is the calculated proton fraction of the organic, n-protic Bronsted acid (C), wherein the degree of protolysis D for diprotic acids where n=2 is 0.2 to 1.9, for triprotic acids where n=3 is 0.3 to 2.8 and for tetraprotic acids where n=4 is 0.4 to 3.7, wherein the organic, n-protic Bronsted acid (C) having the degree of protolysis D 0<D<n is obtained by acid-base reactions with proton transfer by
(α) addition of suitable amounts of at least one suitable Bronsted base (E) to the at least one organic, n-protic Bronsted acid, wherein the Bronsted base (E) contains at least one cation (F) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations.
   or
(β) addition of suitable amounts of at least one suitable Bronsted acid (E′H) to the salt of the at least one organic n-protic Bronsted acid, wherein the salts of the organic n-protic Bronsted acid contains at least one cation (F′) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations (b) addition of suitable amounts of at least one suitable Bronsted acid (E′H) to the salt of the at least one organic n-protic Bronsted acid, wherein the salts of the organic n-protic Bronsted acid contains at least one cation (F′) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations.

In an eleventh embodiment the invention relates to an n-protic Bronsted acid (C) according to the tenth embodiment, wherein the cation (F) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

In a twelfth embodiment the invention relates to an n-protic Bronsted acid (C) according to either of the tenth and eleventh embodiments, wherein the cation (F′) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

In a thirteenth embodiment the invention relates to an n-protic Bronsted acid (C) according to any of the tenth to twelfth embodiments, wherein the at least one Bronsted base (E) is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, scandium hydroxide, titanium hydroxide, zinc hydroxide, aluminum hydroxide, aliphatic primary ammonium hydroxides, aliphatic secondary ammonium hydroxides, aliphatic tertiary ammonium hydroxides, aliphatic quaternary ammonium hydroxides, phosphonium hydroxides, aliphatic primary ammonium alkoxides, aliphatic secondary ammonium alkoxides, aliphatic tertiary ammonium alkoxides, aliphatic quaternary ammonium alkoxides, phosphonium alkoxides, butylithium, potassium tert-butoxide, 1,8-diazabicyclo[5.4.0]undec-7-ene (DBU), 1,5-diazabicyclo(4.3.0)non-5-ene (DBN), primary aliphatic amines, secondary aliphatic amines, tertiary aliphatic amines, primary cycloaliphatic amines, secondary cycloaliphatic amines, tertiary cycloaliphatic amines and phosphonium alkoxides, preferably from sodium hydroxide, potassium hydroxide, lithium hydroxide, magnesium hydroxide, calcium hydroxide, aliphatic quaternary ammonium alkoxides, phosphonium alkoxides, ammonia, triethylamine, trimethylamine, diethylamine, propylamine, methylamine, dimethylamine, ethylamine, ethylenediamine, 1,3-diaminopropanes, putrescine, 1,5-diaminopentane, hexamethylenediamine, 1,2-diaminopropanes, diaminocyclohexane, n-propylamine, di-n-propylamine, tri-n-propylamin, isopropylamine, diisopropylamine, n-butylamine, di-n-butylamine, tri-n-butylamine, diisobutylamine, 2-aminobutane, 2-ethylhexylamine, di-2-ethylhexylamine, cyclohexylamine, dicyclohexylamine, dimethylaminopropylamine, triethylenediamine, 1,8-diazabicyclo[5.4.0]undec-7-ene (DBU) and 1,5-diazabicyclo(4.3.0)non-5-ene (DBN), particularly preferably from sodium hydroxide, potassium hydroxide, lithium hydroxide, magnesium hydroxide, tetra(n-butyl)ammonium methoxide, tetra(n-butyl)ammonium ethoxide and tetra(n-butyl)ammonium isopropoxide.

In a fourteenth embodiment the invention relates to an n-protic Bronsted acid (C) according to any of the tenth to twelfth embodiments, wherein the at least one Bronsted acid (E′H) is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

In a fifteenth embodiment the invention relates to an n-protic Bronsted acid (C) according to any of the tenth to fourteenth embodiments, wherein diprotic acids where n=2 having a degree of protolysis D of 0.8 to 1.8, preferably 1.1 to 1.7, are used.

In a sixteenth embodiment the invention relates to an n-protic Bronsted acid (C) according to any of the tenth to fifteenth embodiments, wherein the n-protic Bronsted acid (C) is at least one sulfonic acid.

In a seventeenth embodiment the invention relates to a sulfonic acid according to any of the tenth to sixteenth embodiments, wherein the sulfonic acid is selected from the group consisting of at least one substituted or unsubstituted naphthalenepolysulfonic acid where n=2 or 3 and/or at least one substituted or unsubstituted benzenepolysulfonic acid where n=2 or 3.

In an eighteenth embodiment the invention relates to a sulfonic acid according to any of the tenth to seventeenth embodiments, wherein the degree of protolysis D for diprotic acids where n=2 is 0.8 to 1.8 and for triprotic acids where n=3 is 1.1 to 2.1.

In a nineteenth embodiment the invention relates to a sulfonic acid according to any of the tenth to eighteenth embodiments, wherein the at least one sulfonic acid is selected from the group consisting of 1,5-naphthalenedisulfonic acid, 2,6-naphthalenedisulfonic acid and 1,3-benzenedisulfonic acid, preferably 1,5-naphthalenedisulfonic acid, 2,6-naphthalenedisulfonic acid and very particularly preferably 2,6-naphthalenedisulfonic acid.

In a twentieth embodiment the invention relates to a sulfonic acid according to the nineteenth embodiment, wherein the degree of protolysis D is 0.8 to 1.8, preferably 1.1 to 1.7.

In a twenty-first embodiment the invention relates to the use of the n-protic Bronsted acid (C) according to any of the tenth to twentieth embodiments as catalyst.

In a twenty-second embodiment the invention relates to a process according to any of the first to ninth embodiments, wherein the compound (BH) is selected from the group consisting of polyether carbonate polyols, polycarbonate polyols, polyether ester carbonate polyols and polymeric formaldehyde compounds.

In a twenty-third embodiment the invention relates to a process according to any of the first to ninth embodiments, wherein the compound (C) is a non-polymeric compound.

In a twenty-fourth embodiment the invention relates to a process according to any of the first to ninth, twenty-second and twenty-third embodiments, wherein the organic, n-protic Bronsted acid (C) has a calculated molar mass of ≤1200 g/mol, preferably of ≤1000 g/mol and particularly preferably of ≤850 g/mol.

In a twenty-fifth embodiment the invention relates to a process according to any of the first to ninth, twenty-second to twenty-fourth embodiments, wherein the organic, n-protic Bronsted acid (C) has a calculated molar mass of ≥90 g/mol, preferably of ≥100 g/mol and particularly preferably of ≥110 g/mol.

In a twenty-sixth embodiment the invention relates to a process according to any of the first to ninth, twenty-second to twenty-fifth embodiments, wherein the organic, n-protic Bronsted acid (C) has a calculated molar mass of ≥90 g/mol to ≤1200 g/mol, preferably of ≥100 g/mol to ≤1000 g/mol and particularly preferably of ≥110 g/mol to ≤850 g/mol.

In a twenty-seventh embodiment the invention relates to a process according to any of the third to ninth embodiments, wherein the sulfonic acid has a calculated molar mass of ≥160 g/mol to <1200 g/mol, preferably of ≥200 g/mol to ≤1000 g/mol and particularly preferably of ≥230 g/mol to ≤850 g/mol.

In a twenty-eighth embodiment the invention relates to an n-protic Bronsted acid (C) according to any of the tenth to twentieth embodiments, wherein the n-protic Bronsted acid (C) has a calculated molar mass of ≥90 g/mol to ≤1200 g/mol, preferably of ≥100 g/mol to ≤1000 g/mol and particularly preferably of ≥110 g/mol to ≤850 g/mol.

In a twenty-ninth embodiment the invention relates to ring-opening products obtainable by a process according to the first to ninth, twenty-second to twenty-seventh embodiments.

In a thirtieth embodiment the invention relates to a polyurethane polymer obtainable by reaction comprising an inventive ring-opening product according to the twenty-ninth embodiment with an isocyanate component comprising a polyisocyanate.

In a thirty-first embodiment the invention relates to a sulfonic acid according to any of the sixteenth to twentieth embodiments, wherein the sulfonic acid has a calculated molar mass of ≥160 g/mol to ≤1200 g/mol, preferably of ≥200 g/mol to ≤1000 g/mol and particularly preferably of ≥230 g/mol to ≤850 g/mol.

### EXAMPLES

The present invention is elucidated in detail by the figures and examples which follow, but without being limited thereto.

### Compounds (A)

Ethylene oxide (3.0, purity≥99.9% by weight, Linde AG)
Propylene oxide (purity 99.9%, Chemogas GmbH)
Styrene oxide (purity 97%, Sigma-Aldrich Chemie GmbH)
Allyl glycidyl ether (purity 99%, Sigma-Aldrich Chemie GmbH)
1,3-Dioxolane (purity 99.8%, Sigma-Aldrich Chemie GmbH)
β-Butyrolactone (purity 98%, Sigma-Aldrich Chemie GmbH)
ε-Caprolactone (purity 97%, Sigma-Aldrich Chemie GmbH)
Maleic anhydride (purity 99%, Sigma-Aldrich Chemie GmbH)
Tetrahydrofuran (absolute, purity 99.9%, Sigma-Aldrich Chemie GmbH)

### Compounds (BH) Having at Least One Zerewitino-Active Hydrogen Atom

### PEG:

Polyethylene glycol having a molecular mass of 1000 g/mol was obtained from Fluka. Before further use the commercially available product was dried over phosphorus pentoxide in a desiccator.

### PET:

Polypropylene glycol (ARCOL® POLYOL 1004) having an average molecular mass of 432 g/mol (hydroxyl number (OH number): 250-270 mg(KOH)/g) was obtained from Covestro AG. Before further use the available product was dried under high vacuum.

PC: CONVERGE® Polyol 212-10, M=1000 g/mol:

Polycarbonate diol from Novomer Inc. CONVERGE® Polyol 212-10 obtainable by reaction of CO2 and propylene oxide having an average molecular mass of 1000 g/mol, a CO2 fraction of about 40% by weight, an OH number of 112 mg(KOH)/g. Analysis of the starting material by proton resonance spectroscopy revealed a content of 3% by weight of cyclic propylene carbonate (cPC).

pFA: Paraformaldehyde (M=450 g/mol)

Paraformaldehyde (trade name: Granuform 96) was obtained from Ineos AG. The number-average molecular mass of the product is specified as 450 g/mol.

### Employed Catalysts/Starting Materials Thereof

1,3-Benzenedisulfonic acid disodium salt: 1,3-Na2-BDS (purity 94%, Sigma-Aldrich Chemie GmbH)
1,5-Naphthalenedisulfonic acid disodium salt: 1,5-Na2-NDS (purity 95%, Sigma-Aldrich Chemie GmbH)
2,6-Naphthalenedisulfonic acid disodium salt: 2,6-Na2-NDS (purity 97%, Sigma-Aldrich Chemie GmbH)
1,5-Naphthalenedisulfonic acid 1,5-NDS (purity 97%, Sigma-Aldrich Chemie GmbH)
Sulfuric acid: H₂SO₄ (purity 98%, Sigma-Aldrich Chemie GmbH)
Trifluoromethanesulfonic acid: CF₃SO₃H (purity 98%, Sigma-Aldrich Chemie GmbH)
Sodium triflate: NaOTf (purity 97%, Sigma-Aldrich Chemie GmbH)
Sodium hydrogensulfate: NaHSO₄ (purity 90%, Sigma-Aldrich Chemie GmbH)
Para-toluenesulfonic acid: p-TSA (purity 98%, Sigma-Aldrich Chemie GmbH)
Fumaric acid C₄H₄O₄: (purity 99%, Sigma-Aldrich Chemie GmbH)
Tetrabutylammonium methoxide solution: (n-Bu)₄N (OMe) (20% methanol solution, Sigma-Aldrich Chemie GmbH)
1,8-Diazabicyclo[5.4.0]undec-7-ene: DBU (purity 98%, Sigma-Aldrich Chemie GmbH)
Perfluorosulfonic acid membrane: Nation® N117-type in a thickness of 0.007 inch with equivalent amount of sulfonyl groups of 0.91-1.11 mmol/g (manufacturer specifications for ion exchange capacity IEC), Sigma-Aldrich Chemie GmbH

### Description of the Methods:

Gel permeation chromatography (GPC): The measurements were performed on an Agilent 1200 Series (G1310A Iso Pump, G1329A ALS, G1316A TCC, G1362A RID, G1365D MWD), detection by RID; eluent: tetrahydrofuran (GPC grade), flow rate 1.0 ml/min; column combination: PSS SDV precolumn 8×50 mm (5 μm), 2×PSS SDV linear S 8×300 ml (5 μm). Polystyrene of known molar mass from “PSS Polymer Standards Service” were used for calibration. The measurement recording and evaluation software used was the “PSS WinGPC Unity” software package. The GPC chromatograms were recorded in accordance with DIN 55672-1. The peak molecular weight (MPeak or M_{P} for short) in the GPC chromatogram corresponds to the molar weight, according to calibration, at maximum detector signal.

The polydispersity index from weighted (M_{w}) and number-average (Mₙ) molecular weight from the gel permeation chromatography is defined as M_{w}/Mₙ.

¹H-NMR spectroscopy (proton resonance spectroscopy): The measurements were performed using a Bruker AV400 instrument (400 MHz); the chemical shifts were calibrated relative to the solvent signal (CDCl₃, δ=7.26 ppm); s=singlet, m=multiplet, bs=broadened singlet, kb=complex region.

¹³C NMR spectroscopy: The measurements were performed using a Bruker AV400 instrument (100 MHz); the chemical shifts were calibrated relative to the solvent signal (CDCl₃, δ=77.16 ppm); HMBC: hetero multiple bond correlation.

The content of polyoxymethylene groups, polypropylene oxide groups and polyethylene oxide groups in the polyol component was determined using ¹H-NMR spectroscopy. The relative contents of the individual increments were determined by integration of the characteristic proton signals. These were also used for quantifying conversions. Characteristic signals of the compounds produced are:

¹H NMR (300 MHz, CDCl₃) δ=1.14 (m, 3H, methyl groups PO); 3.20-3.55 (m, 3H, ethylene groups PO); 3.73 (s, 4H, ethylene groups EO); 4.70-4.90 (m, 2H, methylene groups formaldehyde FA) ppm.

¹³C NMR (75 MHz, CDCl₃) δ=17.4 (methyl groups PO); 66.9-67.5 (ethylene groups PO and EO); 75.5 (ethylene groups PO); 73.0 (ethylene groups PO and EO); 88.0-95.5 (methylene groups formaldehyde FA); 154.8 (carbonate) ppm.

### Catalyst Synthesis

### Synthesis of Catalyst C-1 Employable According to the Invention

To synthesize catalyst C-1 1.182 g of the 1,5-naphthalenedisulfonic acid disodium salt (3.556 mmol; 1.0 eq.) were suspended in 15 ml of absolute dichloromethane under inert conditions. With vigorous stirring, 0.19 ml of 98% sulfuric acid (3.556 mmol; 1.0 eq.) were added. After 10 minutes of stirring the solvent was removed under vacuum and the solid was dried under high vacuum over 4 hours.

The obtained catalyst was used in further reactions without further purification.

### D=1.0

Alternatively, the catalyst C-1 may also be produced directly in the presence of the starter (BH) in analogous fashion with or without dichloromethane.

### Synthesis of Catalyst C-2 Employable According to the Invention

To synthesize catalyst C-2 3.709 g of the 1,3-benzenedisulfonic acid disodium salt (13.158 mmol; 1.0 eq.) were suspended in 30 ml of absolute dichloromethane under inert conditions. With vigorous stirring, 0.70 ml of 98% sulfuric acid (13.158 mmol; 1.0 eq.) were added. After 10 minutes of stirring the solvent was removed under vacuum and the solid was dried under high vacuum over 4 hours.

The obtained catalyst was used in further reactions without further purification.

### D=1.0

Alternatively, the catalyst C-2 may also be produced directly in the presence of the starter (BH) in analogous fashion with or without dichloromethane.

### Synthesis of Catalyst C-3 Employable According to the Invention

To synthesize catalyst C-3 2.000 g of the 1,5-naphthalenedisulfonic acid disodium salt (6.019 mmol; 1.0 eq.) were suspended in 15 ml of absolute dichloromethane under inert conditions. With vigorous stirring, 0.898 ml of trifluoromethanesulfonic acid (1.535 g; 10.233 mmol; 1.7 eq.) were added. After stirring for 10 minutes the solvent was removed under vacuum.

The obtained catalyst C-3 was used in further reactions without further purification.

### D=1.7

Alternatively, the catalyst C-3 may also be produced directly in the presence of the starter (BH) in analogous fashion with or without dichloromethane.

### Synthesis of Catalyst C-4 Employable According to the Invention

Analogously to the preparation of catalyst C-3 the catalyst C-4 was produced with a degree of protonation D of D=1.3. The amount of the trifluoromethanesulfonic acid was employed according to the degree of protonation D=1.3.

### D=1.3

Alternatively, the catalyst C-4 may also be produced directly in the presence of the starter (BH) in analogous fashion with or without dichloromethane.

### Synthesis of Catalyst C-5 Employable According to the Invention

1.171 g (3.525 mmol) of 2,6-naphthalenedisulfonic acid disodium salt were suspended in absolute dichloromethane and admixed with 0.41 ml (4.700 mmol; 0.705 g) of trifluoromethanesulfonic acid. The suspension was stirred over 20 minutes and subsequently concentrated under vacuum.

The obtained catalyst C-5 was used in further reactions without further purification.

### D=1.3

Alternatively, the catalyst C-5 may also be produced directly in the presence of the starter (BH) in analogous fashion with or without dichloromethane.

### Synthesis of Catalyst C-6 Employable According to the Invention

Analogously to the preparation of catalyst C-5 the catalyst C-6 was produced with a degree of protonation D of D=1.7. The amount of the trifluoromethanesulfonic acid was employed according to the degree of protonation D=1.7.

### D=1.7

Alternatively, the catalyst C-6 may also be produced directly in the presence of the starter (BH) in analogous fashion with or without dichloromethane.

### Synthesis of Catalyst C-7 Employable According to the Invention

To synthesize catalyst C-7 32 mg of fumaric acid (0.280 mmol; 1 eq) were dissolved in 0.47 ml of a solution of tetrabutylammonium methoxide (0.280 mmol; 20% in methanol; 1 eq). The obtained mixture was then concentrated to dryness.

The obtained catalyst C-7 was used in further reactions without further purification.

### D=1.0

### Synthesis of Catalyst C-8 Employable According to the Invention

Analogously to the preparation of catalyst C-7 the catalyst C-8 was produced, 1,5-naphthalenedisulfonic acid being employed as the diprotic acid instead of fumaric acid. The degree of protonation of the resulting catalyst C-8 is D=1.0.

TABLE 1
Production of the organic, n-protic Bronsted acid (C) as catalyst

| | Step α | | Step β | | | |
|---|---|---|---|---|---|---|
| | organic, | | salt of the | | | |
| | n-protic | | organic, | | | |
| | Bronsted | | n-protic | | | |
| Catalyst | acid | base (EH) | Bronsted acid | Acid (E′) | D | n |
| C-1 | | | 1,5-Na2-NDS | H2SO4 | 1.0 | 2 |
| C-2 | | | 1,3-Na2-BDS | H2SO4 | 1.0 | 2 |
| C-3 | | | 1,5-Na2-NDS | CF3SO3H | 1.7 | 2 |
| C-4 | | | 1,5-Na2-NDS | CF3SO3H | 1.3 | 2 |
| C-5 | | | 2,6-Na2-NDS | CF3SO3H | 1.3 | 2 |
| C-6 | | | 2,6-Na2-NDS | CF3SO3H | 1.7 | 2 |
| C-7 | Fumaric acid | (n-Bu)₄N | | | 1.0 | 2 |
| | | (OMe) | | | | |
| C-8 | 1,5-NDS | (n-Bu)₄N | | | 1.0 | 2 |
| | | (OMe) | | | | |

### Activity Tests

### Example 1: Reaction of Styrene Oxide with pFA in the Presence of Catalyst C-1

In an inertized Schlenk flask with a magnetic stirrer 12.0 g of finely powdered paraformaldehyde (pFA, M=450 g/mol; 27.500 mmol; 1.00 eq) were suspended in 25 ml of absolute 1,3-dioxolane. The batch was heated to 50° C. and 119 mg of the catalyst C-1 were added with stirring (0.275 mmol; 0.01 eq). Over a period of 72 hours 38 ml of styrene oxide (330.000 mmol; 12 eq) were added dropwise to form a stable white solution. The reaction was monitored by NMR. To this end the crude product was dissolved in dichloromethane, separated from undissolved constituents by filtration and concentrated under vacuum.

The conversion of styrene oxide was 100%.

The number-average molecular weight Mₙ was 1300 g/mol. The molecular weight distribution determined by GPC was monomodal.

The polydispersity index was 1.99.

### Example 2: Reaction of Styrene Oxide with pFA in the Presence of Catalyst C-1

In an inertized Schlenk flask with a magnetic stirrer 44.0 g of finely powdered pFA (M=450 g/mol; 110.000 mmol; 1.00 eq) were suspended in 25 ml of absolute 1,3-dioxolane. The batch was heated to 50° C. and 474 mg of the catalyst C-1 were added with stirring (1.100 mmol; 0.01 eq). Over a period of 48 hours 151 ml of styrene oxide (132.000 mmol; 12 eq) were added dropwise to form a stable white solution. The reaction was monitored by NMR. To this end the crude product was dissolved in dichloromethane, separated from undissolved constituents by filtration and concentrated under vacuum.

The conversion of styrene oxide was 100%.

The number-average molecular weight Mₙ was 1758 g/mol.

The molecular weight distribution determined by GPC was monomodal.

The polydispersity index was 1.90.

### Example 3: (Comparative Example) Reaction of Styrene Oxide with PEG in the Presence of Sodium Hydrogensulfate as Catalyst

In an inertized Schlenk flask with a magnetic stirrer 550 mg of PEG (M=1000 g/mol; 0.550 mmol; 1.00 eq) were heated to 50° C. and 1 mg of sodium hydrogensulfate (0.006 mmol; 0.01 eq) were added with stirring. Subsequently 0.52 ml of styrene oxide were added (4.400 mmol; 8.00 eq) and the reaction mixture was heated to 50° C. over three hours.

The reaction product was analyzed by NMR spectroscopy without further purification.

No conversion of the employed styrene oxide was observed.

### Example 4: Reaction of Propylene Oxide with PEG in the Presence of Catalyst C-5

7.5 mg of 2,6-naphthalenedisulfonic acid disodium salt (0.021 mmol, 0.015 eq) were mixed with 1375 mg of PEG (M=1000 g/mol; 1.375 mmol; 1.00 eq) in an oven-dried pressure-resistant reaction vial. 4 mg of trifluoromethanesulfonic acid (0.028 mmol, 0.02 eq) were added and the mixture was thoroughly commixed at 60° C. At room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 100%.

Mₙ of the product was 1343 g/mol.

### Example 5: Reaction of Propylene Oxide with pFA in the Presence of Catalyst C-4

7.5 mg of 1,5-naphthalenedisulfonic acid disodium salt (0.021 mmol; 0.015 eq) were mixed with 550 mg of finely powdered pFA (M=450 g/mol; 1.375 mmol; 1.00 eq) in an oven-dried pressure-resistant reaction vial. 4 mg of trifluoromethanesulfonic acid (0.028 mmol; 0.02 eq) were added and the mixture was thoroughly commixed. From a total amount of 0.77 ml of propylene oxide (11.000 mmol; 8.0 eq) 0.3 ml were added and the mixture was thoroughly stirred. The addition of propylene oxide was subsequently completed, the reaction vessel was sealed and the mixture was stirred at a temperature of 70° C. over six hours.

Further analysis was performed without workup of the reaction mixture.

The conversion of propylene oxide was 100%.

Mₙ of the product was 730 g/mol.

### Example 6: Reaction of Propylene Oxide with pFA in the Presence of Catalyst C-5

7.5 mg of 2,6-naphthalenedisulfonic acid disodium salt (0.021 mmol; 0.015 eq) were mixed with 550 mg of finely powdered pFA (M=450 g/mol; 1.375 mmol; 1.00 eq) in an oven-dried pressure-resistant reaction vial. 4 mg of trifluoromethanesulfonic acid (0.028 mmol; 0.02 eq) were added and the mixture was thoroughly commixed. From a total amount of 0.77 ml of propylene oxide (11.000 mmol; 8.0 eq) 0.3 ml were added and the mixture was thoroughly stirred. The addition of propylene oxide was subsequently completed, the reaction vessel was sealed and the mixture was stirred at a temperature of 70° C. over six hours.

Further analysis was performed without workup of the reaction mixture.

The conversion of propylene oxide was 100%.

Mₙ of the product was 738 g/mol.

### Example 7: Reaction of Allyl Glycidyl Ether with PEG in the Presence of Catalyst C-6

Under inert gas 2.4 mg of the catalyst 6 (0.004 mmol; 0.8 mol %) were mixed with 500 mg of PEG (M=1000 g/mol; 0.500 mmol; 1.00 eq) in an oven-dried Schlenk tube. At room temperature 0.24 ml of allyl glycidyl ether (2.000 mmol; 4.0 eq) were added, the reaction vessel was sealed and the contents were stirred at a temperature of 60° C. over 8 hours.

Further analysis was performed without workup of the reaction mixture.

The conversion of allyl glycidyl ether was 82%.

The number-average molecular weight Mₙ was 1634 g/mol.

The molecular weight distribution determined by GPC was monomodal in the polymeric range.

The polydispersity index was 1.8.

### Example 8: Reaction of Ethylene Oxide with PET in the Presence of Catalyst C-5

1.171 g (3.525 mmol) of 2.6-naphthalenedisulfonic acid disodium salt were suspended in absolute dichloromethane and admixed with 0.41 ml (4.700 mmol; 0.705 g) of trifluoromethanesulfonic acid. The suspension was stirred over 10 minutes and subsequently concentrated under vacuum. The obtained white solid was then mixed with 10 g of PET (0.023 mol). The thus obtained suspension was transferred into a 2 L high-pressure reactor together with 91.5 g of PET (0.212 mol). The contents were pressurized with nitrogen (1 bar) and subsequently evacuated in three cycles to remove residual air. At a nitrogen pressure of 45 bar the reactor was heated to 45° C. and stirred at 200 rpm. Ethylene oxide 142.9 g (0.94 mol; 8 eq) was added at a rate of 2 ml/min and the reaction temperature was increased at 10° C./15 min until an internal temperature of 105° C. had been achieved (the exothermic reaction was observed above 90° C.). After cooling to 60° C. the ethylene oxide concentration in the gas phase was determined (below 5 ppm) and the reactor was decompressed.

The conversion of ethylene oxide was 100%. The proportion of secondary components was determined as 0.6% by weight.

The number-average molecular weight Mₙ was 740 g/mol.

The molecular weight distribution determined by GPC was monomodal in the entire range.

The polydispersity index was 1.2.

### Example 9: Reaction of Ethylene Oxide with pFA in the Presence of Catalyst C-5

1.220 g (3.673 mmol) of 2,6-naphthalenedisulfonic acid disodium salt were suspended in absolute dichloromethane and admixed with 0.72 g (4.797 mmol) of trifluoromethanesulfonic acid. The suspension was stirred over 10 minutes and subsequently concentrated under vacuum. The obtained white solid was then mixed with 108 g of cPC. The thus obtained suspension was transferred. 105.8 g of pFA (M=450 g/mol, 0.235 mol) were then added. The contents were pressurized with nitrogen (1 bar) and subsequently evacuated in three cycles to remove residual air. At a nitrogen pressure of 45 bar the reactor was heated to 60° C. and stirred at 200 rpm. Ethylene oxide 142.8 g (0.94 mol, 8 eq) was added at a rate of 2 ml/min and the reaction temperature was increased at 10° C./15 min until an internal temperature of 105° C. had been achieved (the exothermic reaction was observed above 90° C.). After cooling to 60° C. the ethylene oxide concentration in the gas phase was determined (below 5 ppm) and the reactor was decompressed.

The conversion of ethylene oxide was 100%. The proportion of secondary components was determined as 8.6% by weight.

The number-average molecular weight Mₙ was 1409 g/mol.

The molecular weight distribution determined by GPC was monomodal in the entire range.

The polydispersity index was 1.9.

### Example 10: Reaction of 1,3-Dioxolane with pFA in the Presence of Catalyst C-2

12 g of finely powdered pFA (0.030 mol; 1.0 eq) were suspended in 12 ml of absolute 1,3-dioxolane under inert conditions. The mixture was heated to 65° C. and the catalyst 2 (342 mg; 0.009 mol; 0.03 eq) was added. The reaction mixture was stirred over 7.5 hours. The product mixture was mixed in 40 ml of dichloromethane, separated from undissolved constituents by filtration and concentrated under vacuum.

Final weight: 10.2 g

The number-average molecular weight Mₙ was 1953 g/mol.

The molecular weight distribution determined by GPC was monomodal.

The polydispersity index was 1.8.

### Example 11: Reaction of Propylene Oxide with PC in the Presence of Catalyst C-5

7.5 mg of 2,6-naphthalenedisulfonic acid disodium salt (0.021 mmol; 0.015 eq) were mixed with 4 mg of trifluoromethanesulfonic acid (0.028 mmol; 0.02 eq) in an oven-dried pressure-resistant reaction vial. 1375 mg of PC (M=1000 g/mol; 1.375 mmol; 1.00 eq) dissolved in 0.77 ml of propylene oxide (11.000 mmol, 8.0 eq) were added and thoroughly stirred. The reaction vessel was sealed and the mixture was stirred at a temperature of 75° C. over five hours.

Further analysis was performed without workup of the reaction mixture.

Complete conversion of the employed propylene oxide with negligible formation of cyclic propylene carbonate was observed. Formation of new cyclic propylene carbonate was determined by proton resonance spectroscopy and amounted to 2.7% of the alternating polycarbonate groups.

The number-average molecular weight Mₙ was 1381 g/mol.

The molecular weight distribution determined by GPC was monomodal.

The polydispersity index was 1.3.

### Example 12: (Comparative Example) Reaction of Propylene Oxide with PC in the Presence of 1,8-diazabicyclo[5.4.0]Undec-7-Ene (DBU) as Catalyst

3 mg of 1,8-diazabicyclo[5.4.0]undec-7-ene (0.015 mmol; 0.015 eq) were initially charged in an oven-dried pressure-resistant reaction vial. 1375 mg of PC (M=1000 g/mol; 1.375 mmol; 1.00 eq) dissolved in 0.77 ml of propylene oxide (11.000 mmol, 8.0 eq) were added and thoroughly stirred. The reaction vessel was sealed and the mixture was stirred at a temperature of 75° C. over five hours.

The reaction product was analyzed by NMR spectroscopy without further purification.

Complete degradation of the polymer to cyclic propylene carbonate was observed. No conversion of employed propylene oxide into polymeric structures was observed.

### Example 13: Reaction of Styrene Oxide with PEG in the Presence of Catalyst C-7

10 mg of catalystr C-7 tetrabutylammonium hydrogenfumarate (0.028 mmol; 0.100 eq) were mixed with 275 mg of PEG (M=1000 g/mol; 0.275 mmol; 1.000 eq). The mixture was heated to 70° C. and 0.13 ml of styrene oxide (1.100 mmol, 4.0 eq) were added. The batch was stirred at 70° C. over 10 hours.

The reaction product was analyzed by NMR spectroscopy without further purification.

The conversion of employed styrene oxide was 28%.

An Mₙ of 1135 g/mol was calculated from the NMR analysis.

### Example 14 (Comparative Example): Reaction of Propylene Oxide with PEG in the Presence of Trifluoromethanesulfonic Acid as Catalyst

Initially charged in an oven-dried pressure-resistant reaction vial were 1375 mg of PEG (M=1000 g/mol; 1.375 mmol; 1.00 eq). 4 mg of trifluoromethanesulfonic acid (CF₃SO₃H, 0.028 mmol, 0.02 eq) were added and the mixture was thoroughly commixed at 60° C. At room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 100%.

The molecular weight distribution determined by GPC was multimodal in the polymeric range and exhibited a high proportion of low molecular weight compounds. Mₙ was 1292 g/mol.

### Example 15 (Comparative Example): Reaction of Propylene Oxide with PC in the Presence of Trifluoromethanesulfonic Acid as Catalyst

Initially charged in an oven-dried pressure-resistant reaction vial were 4 mg of trifluoromethanesulfonic acid (0.028 mmol; 0.02 eq). 1375 mg of PC (M=1000 g/mol; 1.375 mmol; 1.00 eq) dissolved in 0.77 ml of propylene oxide (11.000 mmol, 8.0 eq) were added and thoroughly stirred. The reaction vessel was sealed and the mixture was stirred at a temperature of 75° C. over five hours.

Further analysis was performed without workup of the reaction mixture.

Complete conversion of the employed propylene oxide with severe formation of cyclic propylene carbonate was observed. Formation of new cyclic propylene carbonate was determined by NMR and amounted to 39% of the alternating polyethercarbonate groups.

The number-average molecular weight Mₙ was 808 g/mol.

The molecular weight distribution determined by GPC exhibited high proportions of low molecular weight compounds.

The polydispersity index was 1.6.

### Example 16 (Comparative Example): Reaction of Propylene Oxide with pFA in the Presence of Trifluoromethanesulfonic Acid as Catalyst

Initially charged in an oven-dried pressure-resistant reaction vial were 550 mg of finely powdered pFA (M=450 g/mol; 1.375 mmol; 1.00 eq). 4 mg of trifluoromethanesulfonic acid (0.028 mmol; 0.02 eq) were added and the mixture was thoroughly commixed. From a total amount of 0.77 ml of propylene oxide (11.000 mmol; 8.0 eq) 0.3 ml were added and the mixture was thoroughly stirred. The addition of propylene oxide was subsequently completed, the reaction vessel was sealed and the mixture was stirred at a temperature of 70° C. over six hours.

Further analysis was performed without workup of the reaction mixture.

The conversion of propylene oxide was 100%.

The molecular weight distribution determined by GPC was multimodal in the polymeric range and Mₙ was 476 g/mol.

### Example 17 (Comparative Example): Reaction of Propylene Oxide with PEG in the Presence of 2,6-Naphthalenedisulfonic Acid Disodium Salt as Catalyst

7.5 mg of 2,6-naphthalenedisulfonic acid disodium salt (0.021 mmol, 0.015 eq) were mixed with 1375 mg of PEG (M=1000 g/mol; 1.375 mmol; 1.00 eq) in an oven-dried pressure-resistant reaction vial and the mixture was thoroughly commixed at 60° C. At room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 0%.

### Example 18 (Comparative Example): Reaction of Propylene Oxide with PEG in the Presence of 1,5-Naphthalenedisulfonic Acid Disodium Salt as Catalyst

7.5 mg of 1,5-naphthalenedisulfonic acid disodium salt (0.021 mmol, 0.015 eq) were mixed with 1375 mg of PEG (M=1000 g/mol; 1.375 mmol; 1.00 eq) in an oven-dried pressure-resistant reaction vial and the mixture was thoroughly commixed at 60° C. At room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 0%.

### Example 19 Reaction of Styrene Oxide with PEG in the Presence of Catalyst C-8

In an inertized Schlenk flask with a magnetic stirrer 1375 mg of PEG (M=1000 g/mol; 1.375 mmol; 1.00 eq) were heated to 50° C. and 12 mg of catalyst 8 (0.020 mmol; 0.01 eq) were added with stirring. Subsequently 1.25 ml of styrene oxide were added (11.000 mmol; 8.00 eq) and the reaction mixture was heated to 50° C. over two hours.

The reaction product was analyzed by NMR spectroscopy without further purification.

Complete conversion of the employed styrene oxide was observed by NMR.

Mn of the product was 2209 g/mol.

### Example 20 (Comparative Example): Reaction of Propylene Oxide with PEG in the Presence of Sulfuric Acid as Catalyst

Initially charged in an oven-dried pressure-resistant reaction vial were 3 mg of sulfuric acid, 98% (0.028 mmol; 0.02 eq). 1375 mg of PEG (M=1000 g/mol; 1.375 mmol; 1.00 eq) were added and at room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 8%.

### Example 21 (Comparative Example): Reaction of Propylene Oxide with PEG in the Presence of Sodium Hydrogensulfate as Catalyst

Initially charged in an oven-dried pressure-resistant reaction vial were 4 mg of sodium hydrogensulfate (NaHSO₄, 0.028 mmol; 0.02 eq). 1375 mg of PEG (M=1000 g/mol; 1.375 mmol; 1.00 eq) were added and at room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 0%.

### Example 22 (Comparative Example): Reaction of Propylene Oxide with PEG in the Presence of Sodium Triflate as Catalyst

Initially charged in an oven-dried pressure-resistant reaction vial were 5 mg of sodium triflate (NaOTf, 0.028 mmol; 0.02 eq). 1375 mg of PEG (M=1000 g/mol; 1.375 mmol; 1.00 eq) were added and at room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 0%.

### Example 23 (Comparative Example): Reaction of Propylene Oxide with PEG in the Presence of Sodium Hydrogensulfate-Sodium Triflate Mixture as Catalyst

Initially charged in an oven-dried pressure-resistant reaction vial were 4 mg of sodium hydrogensulfate and 5 mg of sodium triflate (0.028 mmol; 0.02 eq). 1375 mg of PEG (M=1000 g/mol; 1.375 mmol; 1.00 eq) were added and at room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 0%.

### Example 24: Reaction of Propylene Oxide with PC in the Presence of Catalyst C-5

150 mg of 2,6-naphthalenedisulfonic acid disodium salt (0.450 mmol; 0.015 eq) were suspended with 2 ml of absolute dichloromethane in an oven-dried glass flask. 90 mg of trifluoromethanesulfonic acid (0.600 mmol, 0.020 eq) were added with stirring. After stirring for thirty minutes the solvent was removed under vacuum. In a stainless steel reactor with a Teflon lining 30.000 g of PC (M=1000 g/mol, 30.000 mmol, 1.00 eq) of the PC were dissolved in 25 ml of absolute tetrahydrofuran. Subsequently the freshly produced catalyst was added and the reactor was sealed. At room temperature 7.000 g of propylene oxide (120.000 mmol, 4.00 eq) were added and heated to 75° C. with stirring. After a reaction time of two hours a further 7.000 g of propylene oxide were added, so that a total amount of 14.000 g (240.000 mmol, 8.00 eq) was added. After a total reaction time of 5 hours and 30 minutes the mixture was cooled to room temperature and the contents of the reactor were removed.

58.0 g of a clear liquid were obtained and analyzed without further purification.

The conversion of propylene oxide was 100%.

The content of cyclic propylene carbonate determined based on proton resonance spectroscopy was 1.2% by weight based on employed polyether carbonate (the starting material used already contains 3.0% by weight of cyclic propylene carbonate). The proportion of cyclic ethers formed amounted to 8.2% by weight (based on the reaction mixture).

The number-average molecular weight Mₙ was 1633 g/mol.

The polydispersity index was 1.3.

### Example 25 (Comparative Example): Reaction of Propylene Oxide with PC in the Presence of Trifluoromethanesulfonic Acid as Catalyst

In a stainless steel reactor with a Teflon lining 30.000 g of PC (M=1000 g/mol, 30.000 mmol, 1.00 eq) were dissolved in 25 ml of absolute tetrahydrofuran. Subsequently 150 mg of trifluoromethanesulfonic acid (0.600 mmol, 0.02 eq) were added and the reactor was sealed. At room temperature 7.000 g of propylene oxide (120.000 mmol, 4.00 eq) were added and heated to 75° C. with stirring. After a reaction time of two hours a further 7.000 g of propylene oxide were added, so that a total amount of 14.000 g (240.000 mmol, 8.00 eq) was added. After a total reaction time of 5 hours and 30 minutes the mixture was cooled to room temperature and the contents of the reactor were removed.

The conversion of propylene oxide was 100%.

The formation of cyclic propylene carbonate determined based on proton resonance spectroscopy was 22.3% by weight based on employed polycarbonate polyol (the starting material used already contains 3.0% by weight of cyclic propylene carbonate). The proportion of cyclic ethers formed amounted to 13.1% by weight (based on the reaction mixture).

The number-average molecular weight Mₙ was 1340 g/mol.

The polydispersity index was 1.4.

### Example 26: Reaction of Maleic Anhydride with Propylene Oxide and PET in the Presence of Catalyst C-5

300 mg of 2,6-naphthalenedisulfonic acid disodium salt (0.900 mmol; 0.015 eq) were suspended with 8 ml of absolute dichloromethane in an oven-dried glass flask. 180 mg of trifluoromethanesulfonic acid (1.200 mmol, 0.020 eq) were added with stirring. After stirring for thirty minutes the solvent was removed under vacuum. In a stainless steel reactor with a Teflon lining 26.000 g (60.000 mmol, 1.00 eq) of the PET polyol having a molecular weight of 432 g/mol were mixed with 11.769 g of maleic anhydride (120.000 mmol; 2.0 eq). Subsequently the freshly produced catalyst was added and the reactor was sealed. At a temperature of 80° C. a portionwise addition of altogether 28.000 g of propylene oxide (480.000 mmol, 8.00 eq) was performed over 3 hours. Once addition was complete the temperature was increased to 100° C. and the mixture was stirred for a further two hours. Subsequently the mixture was cooled to room temperature and the contents of the reactor were removed. The yellowish liquid was mixed with 40 ml of dichloromethane, filtered via a filter paper to remove undissolved maleic anhydride and subsequently concentrated under vacuum. 48.2 g of a clear light-yellow liquid were obtained (73%).

The conversion of propylene oxide determined based on proton resonance spectroscopy of the unfiltered crude product was 100%. The conversion of employed maleic anhydride was 94%.

The connectivity between incorporated maleic acid equivalents and polyether was demonstrated by 1H-13C-correlated magnetic resonance spectroscopy of the purified product.

The molecular weight MPeak was 1107 g/mol.

The polydispersity index was 1.3.

### Example 27: Reaction of ε-Caprolactone (A-2) with Propylene Oxide (A-1) and PET in the Presence of Catalyst C-5

300 mg of 2,6-naphthalenedisulfonic acid disodium salt (0.900 mmol; 0.015 eq) were suspended with 8 ml of absolute dichloromethane in an oven-dried glass flask. 180 mg of trifluoromethanesulfonic acid (1.200 mmol, 0.020 eq) were added with stirring. After stirring for thirty minutes the solvent was removed under vacuum. In a stainless steel reactor with a Teflon lining 26.000 g (60.000 mmol, 1.00 eq) of the PET polyol having a molecular weight of 432 g/mol were mixed with 13.697 g of ε-caprolactone (120.000 mmol; 2.0 eq). Subsequently the freshly produced catalyst was added and the reactor was sealed. At a temperature of 80° C. a portionwise addition of altogether 28.000 g of propylene oxide (480.000 mmol, 8.00 eq) was performed. After stirring for three hours at 80° C. and stirring for one hour at 100° C. the reaction was terminated. After cooling to room temperature the contents of the reactor were removed (66.4 g; 98%).

The conversion of propylene oxide determined based on proton resonance spectroscopy of the crude product was 100%. The conversion of employed ε-caprolactone was likewise 100%.

The molecular weight MPeak was 1349 g/mol.

The polydispersity index was 1.5.

### Example 28: Reaction of βButyrolactone (A-2) with Propylene Oxide (A-1) and PET in the Presence of Catalyst C-5

300 mg of 2,6-naphthalenedisulfonic acid disodium salt (0.900 mmol; 0.015 eq) were suspended with 8 ml of absolute dichloromethane in an oven-dried glass flask. 180 mg of trifluoromethanesulfonic acid (1.200 mmol, 0.020 eq) were added with stirring. After stirring for thirty minutes the solvent was removed under vacuum. In a stainless steel reactor with a Teflon lining 26.000 g (60.000 mmol, 1.00 eq) of the PET polyol having a molecular weight of 432 g/mol were mixed with 10.330 g of βbutyrolactone (120.000 mmol; 2.0 eq). Subsequently the freshly produced catalyst was added and the reactor was sealed. At a temperature of 80° C. a portionwise addition of altogether 28.000 g of propylene oxide (480.000 mmol, 8.00 eq) was performed. After stirring for three hours the reaction was terminated, cooled to room temperature and the contents of the reactor were removed. The yellowish liquid was mixed with 40 ml of dichloromethane, filtered via a filter paper and subsequently concentrated under vacuum. 54.5 g of a clear light-yellow liquid were obtained (84.0%).

The conversion of propylene oxide determined based on proton resonance spectroscopy of the unfiltered crude product was 100%. The conversion of employed βbutyrolactone was 77%.

The molecular weight MPeak was 1295 g/mol.

The polydispersity index was 1.3.

### Example 29: Reaction of Tetrahydrofuran (A-7) with Propylene Oxide (A-1) and PET in the Presence of Catalyst C-5

300 mg of 2,6-naphthalenedisulfonic acid disodium salt (0.900 mmol; 0.015 eq) were suspended with 8 ml of absolute dichloromethane in an oven-dried glass flask. 180 mg of trifluoromethanesulfonic acid (1.200 mmol, 0.020 eq) were added with stirring. After stirring for thirty minutes the solvent was removed under vacuum. In a stainless steel reactor with a Teflon lining 26.000 g (60.000 mmol, 1.00 eq) of the PET polyol having a molecular weight of 432 g/mol were mixed with 8.654 g of tetrahydrofuran (120.000 mmol; 2.0 eq). Subsequently the freshly produced catalyst was added and the reactor was sealed. At a temperature of 100° C. a portionwise addition of altogether 28.000 g of propylene oxide (480.000 mmol, 8.00 eq) was performed. After stirring for four and a half hours the reaction was terminated, cooled to room temperature and the contents of the reactor were removed. The yellowish liquid was mixed with 40 ml of dichloromethane, filtered via a filter paper and subsequently concentrated under vacuum. 48.3 g of a clear light-yellow liquid were obtained (77%).

The conversion of propylene oxide determined based on proton resonance spectroscopy of the unfiltered crude product was 100%. The conversion of employed tetrahydrofuran was 64%.

The connectivity between incorporated 1,4-dihydroxybutane equivalents and polyether was demonstrated by 1H-13C-correlated magnetic resonance spectroscopy of the purified product.

The molecular weight MPeak was 1132 g/mol.

The polydispersity index was 1.4.

### Example 30: Reaction of 1,3-Dioxolane (A-4) with Propylene Oxide (A-1) and Paraformaldehyde (pFA) in the Presence of Catalyst C-5

187 mg of 2,6-naphthalenedisulfonic acid disodium salt (0.563 mmol; 0.027 eq) were suspended with 0.5 ml of absolute dichloromethane in an oven-dried glass flask. 113 mg of trifluoromethanesulfonic acid were added with stirring. After five minutes of stirring the solvent was removed under vacuum and the pulverulent white solid was mixed with 15.000 g of finely powdered paraformaldehyde pFA (M=450 g/mol; 33.333 mmol; 1.00 eq). The obtained powder was added to a stainless steel reactor with a Teflon lining and therein suspended with 34 ml of absolute 1,3-dioxolane. Subsequently the reactor was sealed and with stirring heated to 60° C. and propylene oxide was added in 5 ml portions. Once 10 ml had been added over a period of 30 minutes the internal temperature of the reactor was increased to 70° C. The addition of propylene oxide was continued up to a total amount of 20 ml (300.000 mmol; 9.0 eq) and the mixture was stirred for a further 18 hours at 70° C.

Complete conversion of the employed propylene oxide was determined by proton magnetic resonance spectroscopy of the crude product mixture.

The obtained solution was mixed with 30 ml of dichloromethane, filtered and concentrated under vacuum. 42.3 g of a yellowish liquid were obtained.

The conversion of propylene oxide was 100%, the yield (including 1,3-dioxolane as comonomer) was 62%.

The content of formaldehyde determined based on proton resonance spectroscopy was 42% by weight.

The number-average molecular weight Mn was 1652 g/mol.

The polydispersity index was 1.5.

### Example 31 (Comparative Example): Reaction of Propylene Oxide with PEG in the Presence of Perfluorosulfonic Acid Membrane (Nation® N117)

31 mg of perfluorosulfonic acid membrane of the type Nafion® N117 comprising an equivalent amount of 0.91-1.11 mmol of sulfonyl groups per gram (0.028 mmol, 0.020 eq) were initially charged in an oven-dried pressure-resistant reaction vial with 1375 mg of PEG (M=1000 g/mol; 1.375 mmol; 1.00 eq). At room temperature 0.77 ml of propylene oxide (11.000 mmol, 8.0 eq) were added, the reaction vessel was sealed and the contents were stirred at a temperature of 60° C. over 1.5 hours.

Further analysis was performed without workup of the reaction mixture.

The conversion of propylene oxide was 16%.

TABLE 2
Test for activity of inventive and comparative catalyst systems with
propylene oxide (A-1), PEG (BH), a reaction temperature of T =
60° C., a reaction time of t = 1.5 h, a molar ratio n(A-1)/n(BH) = 8.

| | | | | | X (A-1) | Mₙ |
|---|---|---|---|---|---|---|
| # | Catalyst | Organic | n | D | [%] | [g/mol] |
| 21 comp. | NaHSO4 | no | 2 | 1.0 | 0 | — |
| 22 comp. | NaOTf | yes | 1 | 0 | 0 | — |
| 23 comp. | NaHSO4/ | yes | 3 | 1.0 | 0 | — |
| | NaOTf | | | | | |
| 14 comp. | CF3SO3H | yes | 1 | 1.0 | 100 | 1292^{a} |
| 18 comp. | 1,5-Na2NDS | yes | 2 | 0 | 0 | — |
| 17 comp. | 2,6-Na2NDS | yes | 2 | 0 | 0 | — |
| 4 | C-5 | yes | 2 | 1.3 | 100 | 1343 |
| 20 comp. | H2SO4 | no | 2 | 2.0 | 8 | — |
| 31 comp. | Nafion ® | yes | — | — | 16 | — |
| | N117 | | | | | |

^{a}multimodal molecular weight distribution.

TABLE 3
Test for activity of inventive and comparative catalyst systems with
styrene oxide (A-1), PEG (BH), a reaction temperature of T =
50° C., a reaction time of t = 2 h, a molar ratio (A-1)/n(BH) = 8.

| | | | | | X (A-1) | Mₙ |
|---|---|---|---|---|---|---|
| # | Catalyst | Organic | n | D | [%] | [g/mol] |
| 19 | C-8 | yes | 2 | 1.0 | 100 | 2209 |
| 3 comp. | NaHSO₄ | no | 2 | 1.0 | 0 | — |

TABLE 4
Test for activity of inventive catalyst system C-6 with AGE
(A-1), PEG (BH), a reaction temperature of T = 60°
C., a reaction time of t = 2 h, a molar ratio (A-1)/n(BH) = 4.

| | | | | | X (A-1) | Mₙ |
|---|---|---|---|---|---|---|
| # | Catalyst | Organic | n | D | [%] | [g/mol] |
| 7 | C-6 | yes | 2 | 1.7 | 82 | 1634 |

TABLE 5
Test for activity of inventive and comparative catalyst systems with
propylene oxide (A-1), pFA (BH), a reaction temperature of T =
70° C., a reaction time of t = 6 h, a molar ratio (A-1)/n(BH) = 8.

| | | | | | X (A-1) | Mₙ |
|---|---|---|---|---|---|---|
| # | Catalyst | Organic | n | D | [%] | [g/mol] |
| 5 | C-4 | yes | 2 | 1.3 | 100 | 730 |
| 6 | C-5 | yes | 2 | 1.3 | 100 | 738 |
| 16 comp. | CF3SO3H | yes | 1 | 1.0 | 100 | 476^{a} |

^{a}Multimodal molecular weight distribution.

TABLE 6
Test for activity of inventive catalyst systems with
styrene oxide (A-1), pFA (BH), a reaction temperature
of T = 50° C., a molar ratio (A-1)/n(BH) = 12.

| | | | | | X (A-1) | Mₙ |
|---|---|---|---|---|---|---|
| # | Catalyst | Organic | n | D | [%] | [g/mol] |
| 1 | C-1 | yes | 2 | 1.0 | 100 | 1300 |
| 2 | C-1 | yes | 2 | 1.0 | 100 | 1758 |

TABLE 7
Test for activity of the inventive catalyst system with
1,3-dioxolane (A-4), pFA (BH), a reaction temperature
of T = 65° C., a molar ratio (A-4)/(BH) = 5.7.

| | | | | | X (A-4) | Mₙ |
|---|---|---|---|---|---|---|
| # | Catalyst | Organic | n | D | [%] | [g/mol] |
| 10 | C-2 | yes | 2 | 1.0 | 37* | 1953 |

*1,3-dioxolane also solvent

TABLE 8
Test for activity and selectivity of inventive and comparative
catalyst systems with propylene oxide (A-1), PC (BH),
a reaction temperature of T = 75° C., a reaction
time of t = 5 h, a molar ratio (A-1)/n(BH) = 8.

| | | | | | | | cPC^{a)} |
|---|---|---|---|---|---|---|---|
| | | | | | X (A-1) | Mₙ | [% by |
| # | Catalyst | Organic | n | D | [%] | [g/mol] | weight] |
| 11 | C-5 | yes | 2 | 1.3 | 100 | 1381 | 2.7 |
| 15 comp. | CF₃SO₃H | yes | 1 | 1.0 | 100 | 808 | 39.0 |

^{a)}Formation of new cyclic propylene carbonate cPC, based on employed polycarbonate polyol PC, less 3% by weight of cPC from starter material.

TABLE 9
Test for activity of inventive catalyst system C-7
with styrene oxide (A-1), PEG (BH), a reaction temperature
of T = 70° C., a molar ratio (A-1)/(BH) = 4.

| | | | | | X (A-1) | Mₙ |
|---|---|---|---|---|---|---|
| # | Catalyst | Organic | n | D | [%] | [g/mol] |
| 13 | C-7 | yes | 2 | 1.0 | 28 | 1135 |

TABLE 10
Copolymerization of propylene oxide (A-1) with comonomers
(A-2, A-4, A-6 or A-7) in the presence of catalyst
(C-5) at temperatures of 80-100° C.

| | | | | | | T | M |
|---|---|---|---|---|---|---|---|
| # | Comonomers | Catalyst | Organic | n | D | [° C.] | [g/mol] |
| 26 | A-1, A-6 | C-5 | yes | 2 | 1.3 | 80-100 | 1107 |
| | | | | | | | (M_{P}) |
| 27 | A-1, A-2 | C-5 | yes | 2 | 1.3 | 80 | 1349 |
| | | | | | | | (M_{P}) |
| 28 | A-1, A-2 | C-5 | yes | 2 | 1.3 | 80 | 1295 |
| | | | | | | | (M_{P}) |
| 29 | A-1, A-7 | C-5 | yes | 2 | 1.3 | 100 | 1132 |
| | | | | | | | (M_{P}) |
| 30 | A-1, A-4 | C-5 | yes | 2 | 1.3 | 60-70 | 1652 |
| | | | | | | | (Mₙ) |

TABLE 11
Test for activity and selectivity of inventive and comparative
catalyst systems with alkylene oxide (A-1), H-functional starter
compounds (BH) with molar ratio (A-1)/n(BH) = 8.

| | | | | | | | | Secondary |
|---|---|---|---|---|---|---|---|---|
| | | | | | X (A-1) | Mn | | components |
| # | (A-1) | (BH) | Catalyst | Solvent | [%] | [g/mol] | PDI | [% by weight] |
| 11 | PO | PC | C-5 | — | 100 | 1381 | 1.3 | 2.7^{a)}/—^{b)} |
| 15 comp. | PO | PC | CF3SO3H | — | 100 | 808 | 1.6 | 39.0^{a)}/—^{b)} |
| 24 | PO | PC | C-5 | THF | 100 | 1633 | 1.3 | 1.2^{a)}/8.2^{b)} |
| 25 comp. | PO | PC | CF3SO3H | THF | 100 | 1340 | 1.4 | 22.3^{a)}/13.1^{b)} |
| 8 | EO | PET | C-5 | — | 100 | 740 | 1.2 | 0^{a)}/0.6^{b)} |
| 9 | EO | pFA | C-5 | cPC | 100 | 1409 | 1.9 | 0^{a)}/8.6^{b)} |

^{a)}Formation of cyclic propylene carbonate (cPC), based on employed polycarbonate polyol, less 3% by weight of cPC from starter material.
^{b)}The proportion of secondary components without cPC based on the reaction mixture in % by weight.

1. A process for addition of a compound (A) onto an H-functional starter compound (BH) in the presence of a catalyst,
wherein the at least one compound (A) is selected from at least one group consisting of alkylene oxide (A-1), lactone (A-2), lactide (A-3), cyclic acetal (A-4), lactam (A-5), cyclic anhydride (A-6) and oxygen-containing heterocycle compound (A-7) distinct from (A-1), (A-2), (A-3), (A-4) and (A-6),
characterized in that
the catalyst comprises an organic, n-protic Bronsted acid (C), wherein n 2 and is an element of the natural numbers and the degree of protolysis D is 0<D<n where n is the maximum number of transferable protons and D is the calculated proton fraction of the organic, n-protic Bronsted acid (C)
wherein the organic, n-protic Bronsted acid (C) has a calculated molar mass of ≤1200 g/mol.

2. The process as claimed in claim 1, wherein the compound (A) is selected from at least one group consisting of alkylene oxide (A-1), lactone (A-2), cyclic acetal (A-4) and cyclic anhydride (A-6).

3. The process as claimed in claim 1, wherein the organic, n-protic Bronsted acid (C) is a sulfonic acid.

4. The process as claimed in claim 1, wherein the maximum number of transferable protons n is n=2, 3 or 4.

5. The process as claimed in claim 4, wherein the degree of protolysis D for diprotic acids where n=2 is 0.2 to 1.9, for triprotic acids where n=3 is 0.3 to 2.8 and for tetraprotic acids where n=4 is 0.4 to 3.7.

6. The process as claimed in claim 1, wherein the organic, n-protic Bronsted acid (C) having the degree of protolysis 0<D<n is obtained by acid-base reactions with proton transfer by
(α) addition of suitable amounts of suitable Bronsted bases (E) to the organic, n-protic Bronsted acids
or
(β) addition of suitable amounts of suitable Bronsted acids (E′H) to the salts of the organic, n-protic Bronsted acids.

7. The process as claimed in claim 6, wherein the organic, n-protic Bronsted acid (C) having the degree of protolysis 0<D<n is obtained by acid-base reactions with proton transfer in step
(α) by addition of Bronsted bases (E) having a pK_{b}(E) of ≤10, preferably having a pK_{b}(E) of 8 and very particularly preferably having a pK_{b}(E) of ≤5 to the completely protonated sulfonic acids
or
(β) by addition of strong Bronsted acids (E′H) having a pKₛ(E′H) of ≤1 to the metal salt of a sulfonic acid.

8. The process as claimed in claim 1, wherein the at least one compound (A) is selected from the group consisting of ethylene oxide, propylene oxide, styrene oxide, allyl glycidyl ether, ε-caprolactone, propiolactone, β-butyrolactone, γ-butyrolactone, ε-caprolactam, 1,3-dioxolane, 1,4-dioxane, tetrahydrofuran and 1,3,5-trioxane.

9. The process as claimed in claim 1, wherein the compound (BH) is one or more compounds and is selected from the group consisting of mono- or polyvalent alcohols, polyvalent amines, polyvalent thiols, amino alcohols, thio alcohols, hydroxy esters, polyether polyols, polyester polyols, polyester ether polyols, polyether carbonate polyols, polycarbonate polyols, polycarbonates, polyacetals, polymeric formaldehyde compounds, polyethyleneimines, polyetheramines, polytetrahydrofurans, polytetrahydrofuranamines, polyether thiols, polyacrylate polyols, castor oil, the mono- or diglyceride of ricinoleic acid, monoglycerides of fatty acids, chemically modified mono-, di- and/or triglycerides of fatty acids and C1-C24 alkyl fatty acid esters containing on average at least 2 OH groups per molecule.

10. An n-protic Bronsted acid (C) having a degree of protolysis D of 0<D<n, wherein n is the maximum number of transferable protons where n=2, 3 or 4 and D is the calculated proton fraction of the organic, n-protic Bronsted acid (C),
characterized in that
the degree of protolysis D for diprotic acids where n=2 is 0.2 to 1.9, for triprotic acids where n=3 is 0.3 to 2.8 and for tetraprotic acids where n=4 is 0.4 to 3.7,
wherein the organic, n-protic Bronsted acid (C) having the degree of protolysis 0<D<n is obtained by acid-base reactions with proton transfer by
(β) addition of suitable amounts of at least one suitable Bronsted base (E) to the at least one organic, n-protic Bronsted acid, wherein the Bronsted base (E) contains at least one cation (F) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations
or
(χ) addition of suitable amounts of at least one suitable Bronsted acid (E′H) to the salt of the at least one organic, n-protic Bronsted acid, wherein the salts of the organic, n-protic Bronsted acid contains at least one cation (F′) selected from the group consisting of alkali metal-containing, alkaline earth metal-containing, metalloid-containing, transition metal-containing, lanthanoid metal-containing, aliphatic ammonium-containing and phosphonium-containing and sulfonium-containing cations, wherein the n-protic Bronsted acid (C) is at least one sulfonic acid and wherein the at least one sulfonic acid is selected from the group consisting of 1,5-naphthalenedisulfonic acid, 2,6-naphthalenedisulfonic acid and 1,3-benzenedisulfonic acid, preferably 1,5-naphthalenedisulfonic acid, 2,6-naphthalenedisulfonic acid, and very particularly preferably 2,6-naphthalenedisulfonic acid.

11. The n-protic Bronsted acid (C) as claimed in claim 10, wherein the cation (F) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

12. The n-protic Bronsted acid (C) as claimed in claim 10, wherein the cation (F′) is selected from the group consisting of lithium cation, sodium cation, potassium cation, rubidium cation, cesium cation, magnesium cation, calcium cation, strontium cation, barium cation, scandium cation, titanium cation, zinc cation, aluminum cation, aliphatic primary ammonium ions, aliphatic secondary ammonium ions, aliphatic tertiary ammonium ions, aliphatic quaternary ammonium ions, phosphonium ions, sulfonium ions and sulfoxonium ions, preferably from lithium cation, sodium cation, potassium cation, magnesium cation, calcium cation, quaternary ammonium ions and triphenylphosphonium ions and particularly preferably from sodium cation, potassium cation, magnesium cation and n-butylammonium ion.

13. The n-protic Bronsted acid (C) as claimed in claim 10, wherein the at least one Bronsted base (E) is selected from the group consisting of lithium hydroxide, sodium hydroxide, potassium hydroxide, rubidium hydroxide, cesium hydroxide, magnesium hydroxide, calcium hydroxide, strontium hydroxide, barium hydroxide, scandium hydroxide, titanium hydroxide, zinc hydroxide, aluminum hydroxide, aliphatic primary ammonium hydroxides, aliphatic secondary ammonium hydroxides, aliphatic tertiary ammonium hydroxides, aliphatic quaternary ammonium hydroxides, phosphonium hydroxides, aliphatic primary ammonium alkoxides, aliphatic secondary ammonium alkoxides, aliphatic tertiary ammonium alkoxides, aliphatic quaternary ammonium alkoxides, phosphonium alkoxides, butylithium, potassium tert-butoxide, 1,8-diazabicyclo[5.4.0]undec-7-ene (DBU), 1,5-diazabicyclo(4.3.0)non-5-ene (DBN), primary aliphatic amines, secondary aliphatic amines, tertiary aliphatic amines, primary cycloaliphatic amines, secondary cycloaliphatic amines, tertiary cycloaliphatic amines and phosphonium alkoxides, preferably from sodium hydroxide, potassium hydroxide, lithium hydroxide, magnesium hydroxide, calcium hydroxide, aliphatic quaternary ammonium alkoxides, phosphonium alkoxides, ammonia, triethylamine, trimethylamine, diethylamine, propylamine, methylamine, dimethylamine, ethylamine, ethylenediamine, 1,3-diaminopropanes, putrescine, 1,5-diaminopentane, hexamethylenediamine, 1,2-diaminopropanes, diaminocyclohexane, n-propylamine, di-n-propylamine, tri-n-propylamin, isopropylamine, diisopropylamine, n-butylamine, di-n-butylamine, tri-n-butylamine, diisobutylamine, 2-aminobutane, 2-ethylhexylamine, di-2-ethylhexylamine, cyclohexylamine, dicyclohexylamine, dimethylaminopropylamine, triethylenediamine, 1,8-diazabicyclo[5.4.0]undec-7-ene (DBU) and 1,5-diazabicyclo(4.3.0)non-5-ene (DBN), particularly preferably from sodium hydroxide, potassium hydroxide, lithium hydroxide, magnesium hydroxide, tetra(n-butyl)ammonium methoxide, tetra(n-butyl)ammonium ethoxide and tetra(n-butyl)ammonium isopropoxide.

14. The n-protic Bronsted acid (C) as claimed in claim 10, wherein the at least one Bronsted acid (E′H) is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluorantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

15. (canceled)

16. Sulfonic acid as claimed in claim 10, wherein the degree of protolysis D is 0.8 to 1.8, preferably 1.1 to 1.7.
